(19) United States
(12) Patent Application Publication
(10) Pub. No.: US 2019/0172112 A1
(43) Pub. Date: Jun. 6, 2019

(54) MOTOR VEHICLE SALES SYSTEM

(71) Applicant: Dealer Trade Holdings Limited, Brisbane (AU)

(72) Inventor: JARROD SIEROCKI, Brisbane (AU)

(73) Assignee: Dealer Trade Holdings Limited, Brisbane (AU)

(21) Appl. No.: 16/324,794

(22) PCT Filed: Aug. 31, 2017
(86) PCT No.: PCT/AU2017/050934

§ 371 Date: Feb. 11, 2019

(30) Foreign Application Priority Data
Aug. 31, 2016 (AU) 20116903476

(51) Int. Cl. G06Q 30/06

(52) U.S. Cl. CPC G06Q 30/0611; G06Q 30/0609

(57) ABSTRACT

An online motor vehicle sales method including at least one server, the method including the steps of: (a) Generating, with an online motor vehicle sales system, a motor vehicle sale offer from a seller, the sale offer including information received from two or more external electronic databases in communication with the online motor vehicle sales system; (b) Maintaining an electronic database of one or more buyers in association with the online motor vehicle sales system; (c) Sending, with the online motor vehicle sales system, the motor vehicle sale offer to at least one of the one or more buyers; (d) Receiving, with the online motor vehicle sales system, a purchase offer from at least one of the buyers to whom the motor vehicle sale offer was sent; (e) Accepting, with the online motor vehicle sales system, a preferred purchase offer; and (f) Sending, with the online motor vehicle sales system, a notification regarding the acceptance of the preferred purchase offer to the buyer who made the preferred purchase offer.

### TECHNICAL FIELD

The present invention relates to a motor vehicle sales system. In particular, the present invention relates to an online motor vehicle sales system.

### BACKGROUND ART

Traditionally, one of the main ways in which motor vehicle dealers have purchased stock for sale is through motor vehicle auctions. For the party selling a motor vehicle, this involves transporting the vehicle to the location of the auction with no guarantee that the car will sell at all, let alone for the desired price.

Similarly, potential buyers may not end up purchasing any vehicles at an auction, either because the vehicles are unsuitable for their needs or because they are outbid by other buyers. In this situation, the time of the potential buyer has been wasted.

In addition, there may be circumstances that prevent potential buyers from attending an auction, such as the auction being held at a location that is too far to travel to, or because the potential buyer cannot spare the time to attend the auction.

Thus, there would be an advantage if it were possible to provide a motor vehicle sales system that minimised the costs and risks to both buyers and sellers and that allowed buyers to purchase motor vehicles regardless of the location of the vehicle and the buyer.

It will be clearly understood that, if a prior art publication is referred to herein, this reference does not constitute an admission that the publication forms part of the common general knowledge in the art in Australia or in any other country.

### SUMMARY OF INVENTION

The present invention is directed to a motor vehicle sales system which may at least partially overcome at least one of the abovementioned disadvantages or provide the consumer with a useful or commercial choice.

With the foregoing in view, the present invention in one form, resides broadly in an online motor vehicle sales method including at least one server, the method including the steps of:
(a) Generating, with an online motor vehicle sales system, a motor vehicle sale offer from a seller, the motor vehicle sale offer including information received from two or more external electronic databases in electronic communication with the online motor vehicle sales system;
(b) Maintaining an electronic database of one or more buyers in association with the online motor vehicle sales system;
(c) Sending, with the online motor vehicle sales system, the motor vehicle sale offer to at least one of the one or more buyers;
(d) Receiving, with the online motor vehicle sales system, a purchase offer from at least one of the buyers to whom the motor vehicle sale offer was sent;
(e) Accepting, with the online motor vehicle sales system, a preferred purchase offer; and
(f) Sending, with the online motor vehicle sales system, a notification regarding the acceptance of the preferred purchase offer to the buyer who made the preferred purchase offer.

Preferably, the seller generates the motor vehicle sale offer using a motor vehicle sale offer interface which is produced and displayed on an electronic display device according to instructions stored in the memory of a computer device which is a part of, or is accessible by, the online motor vehicle sales system. Changes to the interface produced and displayed are preferably made and/or a new interface is produced and displayed depending upon the instructions and/or interaction that a user has with the interface, and thereby with the online motor vehicle sales system.

It is envisaged that different users of the online motor vehicle sales system may be provided with different levels of access to the online motor vehicle sales system. For instance, a user may be provided with access primarily to the portion of the online motor vehicle sales system that relates to the generation of motor vehicle sale offers, and may be prevented from generating purchase offers. More preferably, however, all users of the online motor vehicle sales system may be provided with access to the online motor vehicle sales system such that a user can generate both motor vehicle sales offers and purchase offers.

In some embodiments of the invention, at least one user may be classified as an administrator. An administrator may have access to all portions of the online motor vehicle sales system, including access to the accounts of other users. An administrator may have the power to add, suspend and/or remove users from the electronic database and online motor vehicle sales system.

The level of access a user has to the online motor vehicle sales system is preferably assigned by the administrator. Users may be provided with user names and/or passwords to access the online motor vehicle sales system using any suitable device. For instance, users may access the online motor vehicle sales system using any suitable electronic device. Preferably, however, the device includes a processor, electronic memory and a display. Thus, the device may comprise a desktop computer, laptop computer, computing tablet, mobile telephone, PDA or the like, or any suitable combination thereof.

In some embodiments of the invention, a user may access the online motor vehicle sales system through a website. Alternatively, the online motor vehicle sales system may be accessed by a user through an application, such as an application downloaded to a mobile phone, computing tablet or the like.

It is envisaged that the online motor vehicle sales system may be housed on a server by the administrator, and users are able to gain access to the online motor vehicle sales system through an internet connection whereby the user remotely accesses the online motor vehicle sales system. Preferably, the online motor vehicle sales system is provided with one or more user interfaces that are displayed on the display of the electronic device the user uses to access the online motor vehicle sales system.

In some embodiments, all users may access the same user interface. In other embodiments, the user interface that a user can access may be determined by the level of access granted to that user. It is envisaged that what an interface allows a user to do within the online motor vehicle sales system will be limited to only the relevant functionality for the user's level of access.

In a preferred embodiment of the invention, a user (whether a seller or buyer) may be required to register with the online motor vehicle sales system before access to the online motor vehicle sales system may be granted. A user may register by contacting an administrator and requesting registration. More preferably, however, registration is automated using the online motor vehicle sales system.

In embodiments of the invention in which registration is automated, registration may be limited to users who can supply one or more predetermined pieces of information. For instance, registration may be limited to users having a registered business number or company number, a local business address or the like, or any suitable combination thereof. In a most preferred embodiment of the invention, however, registration may be limited to users who hold a current motor vehicle dealer licence. In some embodiments of the invention, registration may be further restricted to users holding a current motor vehicle dealer licence issued by one or more specific authorities (country, state, province, region etc.).

In a preferred embodiment of the invention, the online motor vehicle sales system may be provided with a registration interface into which a user may enter their registration information. The registration information may include one or more of the following: name, address, telephone number, email address, registered business or company name, registered business or company number, motor vehicle dealer licence number, date of birth and the like. More preferably, the user may be required to enter a motor vehicle dealer number and one or more of their name, address, telephone number, email address, registered business or company name, registered business or company number, date of birth and the like into the registration interface.

It is envisaged that, once the user has entered the required information into the registration interface, the online motor vehicle sales system may access one or more electronic databases to verify that the information supplied by the user is valid. The one or more electronic databases may include the electronic database of the one or more buyers, or may be a different electronic database. In some embodiments, the electronic database may be an external database, such as an electronic database maintained by a government authority (such as a government authority that issues motor vehicle dealer licences).

If the online motor vehicle sales system is unable to verify that the information supplied by the user is valid, the user's application for registration will be refused. Alternatively, if the online motor vehicle sales system is able to verify that the information supplied by the user is valid, the user's registration will be accepted.

If the user's registration is accepted, the user may then immediately gain access to the online motor vehicle sales system. Preferably, however, if the if the online motor vehicle sales system is able to verify that the information supplied by the user is valid, the user may be sent an access key with which to access the online motor vehicle sales system. Any suitable access key may be sent to the user, although in a preferred embodiment of the invention, the access key may comprise a password, numerical code or the like. The access key may be sent to the user in any suitable manner, although preferably the access key is sent to the user electronically in an email message, text message or the like. In this embodiment of the invention, the user may be required to enter the access key into an interface of the online motor vehicle sales system before gaining access to the online motor vehicle sales system.

In some embodiments of the invention, a user may be registered as an individual. Alternatively, a user's registration may be associated with a group registration. For instance, a vehicle dealership or similar business that employs a plurality of motor vehicle dealers may be provided with a dealership registration, and the registrations of individual motor vehicle dealers may be associated with the dealership registration. As new motor vehicle dealers are employed by the dealership, they may have their registrations associated with the dealership (either by generating a new registration, or by transferring an existing registration to the dealership). Similarly, motor vehicle dealers that end their employment with the dealership may be their registrations removed from the dealership registration (either by being deleted or transferred to the individual or another dealership).

The ability to associate multiple individual motor vehicle dealers with a single dealership registration has numerous benefits. Firstly, it ensures that the owner, principal or manager of the dealership is able to track all transactions made by motor vehicle dealers in their employ. This information may be of use for both performance monitoring purposes, or for the purposes of tracking expenditure across the business.

In addition, associating individual motor vehicle dealers with a dealership registration minimises or eliminates the ability of individual motor vehicle dealers to conduct transactions without the knowledge or approval of the owner, principal or manager of the dealership.

If desired, a user may be required to pay a fee to the online motor vehicle sales system in order to complete its registration.

As previously stated, a seller (who, in a most preferred embodiment of the invention, is a registered user of the online motor vehicle sales system) generates a motor vehicle sale offer that is received by the online motor vehicle sales system. Preferably, the motor vehicle sale offer is generated using a sale offer interface of the online motor vehicle sales system.

Preferably, the seller is required to enter one or more pieces of information regarding the motor vehicle to be sold into the sale offer interface. Any suitable information may be provided, such as, but not limited to, vehicle make, model, colour, odometer reading, registration number, vehicle identification number (VIN), year of manufacture, sale price and the like, or any suitable combination thereof.

In a particular embodiment of the invention, the seller may be required to enter only one piece of information into the sale offer interface. In this embodiment of the invention, the piece of information is preferably the motor vehicle registration number. In some embodiments of the invention, the seller may also be required to enter the state, province or country in which the vehicle has been registered. Further, the seller may also ne required to enter the year of manufacture of the vehicle.

The motor vehicle registration number may be entered into the online motor vehicle sales system in any suitable form. In one embodiment of the invention, for instance, the motor vehicle registration number may be entered by the user typing the motor vehicle registration number into the a sale offer interface of the online motor vehicle sales system. Alternatively, the online motor vehicle sales system may be provided with a speech recognition function so that, when the user says the motor vehicle registration number, the online motor vehicle sales system may convert the user's speech into text or data.

In other embodiments of the invention, the user may upload a file containing the motor vehicle registration number to the online motor vehicle sales system. Any suitable file may be used, although in a preferred embodiment of the invention the file may be an electronic file, such as an image file (e.g. a photograph of the vehicle licence plate). In this embodiment of the invention, the online motor vehicle sales system may be provided with a character recognition function so that, when the user uploads an image of the vehicle licence plate, the online motor vehicle sales system may convert the image of the vehicle licence plate into text or data.

In a particular embodiment of the invention, the user may also enter a vehicle's vehicle identification number (VIN) into the online motor vehicle sales system. As with the motor vehicle registration number, the VIN may be entered in any suitable manner, for instance by typing the number into the online motor vehicle sales system, through speech recognition (in which the user's speech is converted into text or data) or through uploading an image (such as a photograph) of the VIN (and specifically, the plate attached to the motor vehicle on which the VIN is located).

While it is envisaged that the online motor vehicle sales system could access the electronic databases to obtain further information on the motor vehicle using the VIN, in a preferred embodiment of the invention, the VIN entered by the user may be stored in the online motor vehicle sales system for future reference.

It is envisaged that, once the user has entered the motor vehicle registration number into the sale offer interface, the online motor vehicle sales system may access the two or more external electronic databases to automatically generate further information for the sale offer and/or to verify that the sale offer is valid and may proceed. The two or more external electronic databases may include an external electronic database maintained by a government authority (such as a government authority responsible for the registration of motor vehicles). The online motor vehicle sales system may access one or more further external electronic databases to determine other information regarding the vehicle, such as whether there are securities registered over the vehicle, whether there are outstanding fines attributed to the vehicle, whether the vehicle has been reported as stolen and so on. Preferably, this further information is obtained by the online motor vehicle sales system providing the external electronic database with the motor vehicle registration number. On provision of the motor vehicle registration number, the external electronic database may provide the further information corresponding to the motor vehicle registration number.

In this embodiment of the invention, the further information received from the external electronic database may include information such as the vehicle identification number (VIN), vehicle make, model, year of manufacture and the like.

Preferably, in embodiments of the invention in which the VIN is entered by the user and stored in the online motor vehicle sales system, the online motor vehicle sales system may perform a check of the VIN entered by the user against the VIN received from the external electronic database. If the VINs match, the user may continue generating the motor vehicle sale offer. However, if the VIN entered by the user does not match the VIN received from the external electronic database, the online motor vehicle sales system may generate one or more alarms or alerts to inform the user that the VINs do not match. These alarms or alerts may be in the form of a visual or audible signal, or may be a message displayed in the sale offer interface. Alternatively, the online motor vehicle sales system may send an electronic message (such as a text message, email message or the like) to the user to inform the user of the mismatched VINs.

It is envisaged that the VIN entered by the user and the VIN received from the external electronic database may not match if, for instance, the vehicle registration plates are stolen from another vehicle or counterfeit. Thus, the user may be alerted to the fact that the sale of the vehicle may not be valid.

Preferably, once the further information has been received from the external electronic database, and (if applicable) the VIN entered by the user is confirmed as a match to the VIN received from the external electronic database, the online motor vehicle sales system may then access one or more further external electronic databases to automatically generate other information for the sale offer and/or to verify that the sale offer is valid and may proceed. The one or more further electronic databases may include an electronic database electronic database maintained by a government authority, or an electronic database maintained by a company or individual. In a specific embodiment of the invention, the further external electronic database may include a database maintained by the Insurance Institute for Highway Safety (IIHS), the Highway Loss Data Institute (HLDI) or by a company such as Glass's.

Any suitable information may be received from the one or more further external electronic databases. In a preferred embodiment of the invention, however, the other information received from the further external electronic databases may include a National Vehicle Identification Number (NVIC), vehicle manufacture year, vehicle specifications (such as capacity, transmission, retail name, release date, discontinuation date, number of doors, height, width, length, number of seats, suspension type, fuel type, fuel consumption, tyre type, brake information and the like), a price guide (including private sale prices, dealer trade prices, dealer retail prices, recommended retails prices and the like), engine information (such as the name, configuration name, valve gear name, number of valves, compression ratio, bore, stoke, power, torque and the like), rating information (such as the overall rating, greenhouse rating, CO₂ emissions, air pollution rating, safety rating and the like) or warranty and service information (such as warranty and service periods, service months, service kilometres/miles and the like).

In some embodiments of the invention, the additional information received by the online motor vehicle sales system may be obtained from one external electronic database. Alternatively, the information may be obtained from two or more external electronic databases. The information may be obtained simultaneously from the two or more external electronic databases, or may be obtained in a series of steps. For instance, in one embodiment of the invention, the online motor vehicle sales system may use the motor vehicle VIN to obtain the NVIC from a first external electronic database, and the NVIC may be subsequently used to obtain the remaining information from a second external electronic database.

In a preferred embodiment of the invention, the online motor vehicle sales system may automatically populate at least one of the fields into which information regarding the vehicle may be entered into the sale offer interface with information received from the two or more external electronic databases.

In some embodiments of the invention, the seller may customise certain aspects of the sale offer by entering further information into the sale offer interface. For instance, the seller may select the length of time for which the sale offer remains open (for instance, one hour, one day, one week etc. or any other suitable period of time), or may schedule a particular time at which the sale offer may become available to buyers. The seller may also optionally enter a preferred sale price for the vehicle. In other embodiments of the invention, the seller may upload one or more photographs of the vehicle, one or more videos of the vehicle or one or more maps of the location of the vehicle (or any suitable combination thereof) to the sale offer interface.

It is envisaged that, if the seller does not select the length of time for which the sale offer will remain open, the online motor vehicle sales system will automatically set an end time for the sale offer of 24 hours after the sale offer has been sent to the online motor vehicle sales system.

In other embodiments of the invention, the seller may be able to select the buyer or buyers to which the sale offer may be made available. For instance, the seller may elect to select only buyers that buy a particular make of motor vehicle. Alternatively, the select may be able to select buyers within a particular geographic area, such as within a state, city or within a particular distance from the seller. In other embodiments of the invention, the seller may select the buyer or buyers to which the sale offer may be made available on the basis of buyers with whom the seller has had previous business dealings, or may select the buyer or buyers so as to exclude direct competitors from the sale offer.

In other embodiments of the invention, the online motor vehicle sales system may include one or more groups or networks of buyers to which the seller may make the sale offer available. The groups or networks may be created in the online motor vehicle sales system by the seller, the buyers, or may be generated automatically by the online motor vehicle sales system based on any suitable factor, such as geographic location, buyer feedback rating and so on.

In embodiments of the invention in which the groups or networks are generated by the seller or buyers, the seller or buyer may invite other registered users of the online motor vehicle sales system to join a group or network. Alternatively, a registered user may request to join a group or network. In some embodiments of the invention, a request to join a group or network may be automatically accepted, while in other embodiments of the invention, the request may be either accepted or declined by one or more group members.

In a preferred embodiment of the invention, the online motor vehicle sales system may allow a user to search for or browse existing groups or networks.

Once sufficient information has been entered into the sale offer interface to complete the sale offer, the seller may send the sale offer to one or more buyers via the online motor vehicle sales system. In a preferred embodiment of the invention, the sale offer is completed on, and sent from, the electronic device used by the seller to access the online motor vehicle sales system. The sale offer is received by the online motor vehicle sales system and is then sent to the one or more buyers from the online motor vehicle sales system. Preferably, when a sale offer is received, the online motor vehicle sales system consults the electronic database of one or more buyers (for instance, to gather contact information) before sending the sale offer to the one or more buyers.

It is envisaged that the sale offer will be sent electronically to one or more electronic devices associated with the one or more buyers. For instance, the sale offer may be sent to the one or more buyers as an email message, a text message or as a notification associated with an application.

In some embodiments of the invention, the sale offer may be sent to all of the buyers in the electronic database. Alternatively, the sale offer may be sent to a portion of the buyers in the electronic database. Thus, in some embodiments of the invention, a buyer may be able to select what sales offers are received, and/or a seller may be select what buyers receive a sales offer.

In embodiments of the invention in which the buyer is able to select what sales offers are received, it is envisaged that a buyer may be able to add one or more filters to their profile in the electronic database so that any sales offers that do not match the buyer's preferences are not sent to the buyer. For instance, the buyer may be able to add filters so that only sales offers relating to certain makes or models of motor vehicles are sent to it. Similarly, the buyer may be able to add filters so that only sales offers for vehicles within a particular price range, or vehicles with an odometer reading below a particular value, are sent to it. In other embodiments of the invention, buyers may be able to add a filter so that only sales offers for vehicles located within a particular distance of the buyer are sent to it.

The seller may be able to add one of more filters to its profile in the electronic database so that any sales offers it generates are only sent to suitable buyers. For instance, the seller may add a filter so that only buyers located within a certain distance of the motor vehicle's location received the sale offer. Alternatively, the seller may add a filter so that sales offers are not sent to its direct competitors.

It is envisaged that, upon receipt of a sale offer, a buyer may elect to make a purchase offer for the motor vehicle using the online motor vehicle sales system. Thus, in some embodiments of the invention, the online motor vehicle sales system may further comprise a purchase offer interface in which a buyer may generate a purchase offer.

In a preferred embodiment of the invention, the purchase offer may comprise a price that the buyer is prepared to pay for the vehicle. Preferably, the buyer may enter the price into the online motor vehicle sales system (or purchase offer interface) using its electronic device before submitting the purchase offer to the online motor vehicle sales system.

Upon receipt of the purchase offer, the online motor vehicle sales system may send at least one purchase offer to the seller. For instance, the purchase offer may be sent to the seller as an email message, a text message or as a notification associated with an application. In some embodiments of the invention, the purchase offer may be sent to the seller immediately upon receipt from the buyer. Alternatively, the purchase offer may only be sent to the seller after the expiry of the period of time that the seller wished the sale offer to remain open.

In some embodiments of the invention, all purchase offers received from the one or more buyers may be sent to the seller. Alternatively, only the purchase offer with the highest purchase price may be sent to the seller. More preferably, some but not all of the purchase offers may be sent to the seller. In this embodiment of the invention, it is envisaged that only a relatively small number of purchase offers having the highest purchase prices may be sent to the seller. For instance, only the purchase offers representing up to the five highest purchase prices may be sent to the seller. In this way, the seller can quickly make a selection from the highest offers to purchase the vehicle.

In an alternative embodiment of the invention, the sale offer may function as an auction. In this embodiment of the invention, a buyer may view the current highest purchase offer so that buyers can ensure that any subsequent purchase offer includes a purchase price higher than the current highest bid. A seller may elect to begin the auction immediately upon completion of the sale offer or may schedule the timing of the auction at a time suitable to the seller. Alternatively, the online motor vehicle sales system may only permit auctions to be held at particular times (i.e. on particular days, or at a particular time during the day). Thus, all auctions may take place simultaneously. By scheduling auctions to occur simultaneously at set times, it may be ensured that the maximum number of potential buyers are aware of the auction and may make themselves available to access the online motor vehicle sales system at the time of the auctions.

In some embodiments of the invention, buyers may be limited to offering a single purchase price per sale offer. Alternatively, a buyer may make multiple purchase offers during the duration of the sale offer. Multiple purchase offers may be made when, for instance, an earlier purchase price is outbid by another buyer and the outbid buyer wishes to increase their purchase offer.

In embodiments of the invention in which a seller indicates the purchase price that it would like to receive for a motor vehicle, the sale offer may end as soon as a buyer makes a purchase offer that matches or exceeds the seller's desired purchase price. In this embodiment, a buyer that makes a purchase offer that matches or exceeds the seller's desired purchase price may automatically have its purchase offer accepted by the online motor vehicle sales system.

It is envisaged that, if a buyer does not wish to make a purchase offer for the motor vehicle contained in the sale offer, the buyer may reject or delete the sale offer. Alternatively, the buyer may simply ignore the sale offer.

Upon receipt of the purchase offers, the seller may view each purchase offer and then, if satisfied with the purchase price contained in a purchase offer, accept a purchase offer using the online motor vehicle sales system. It is envisaged that, when the online motor vehicle sales system receives notification of the acceptance of a purchase offer by a seller, the online motor vehicle sales system may generate and send an acceptance notification to the buyer whose purchase offer has been accepted. It is envisaged that the acceptance notification will be sent electronically to one or more electronic devices associated with the successful buyer. For instance, the acceptance notification be sent to the successful buyer as an email message, a text message or as a notification associated with an application.

Optionally, notifications regarding the non-acceptance of purchase offers may also be sent to any unsuccessful buyers.

In some embodiments of the invention, the online motor vehicle sales system may further comprise a payment interface. It is envisaged that, in this embodiment of the invention, users of the online motor vehicle sales system may register their financial details (bank account details, trust find details, credit card details etc.) with the online motor vehicle sales system. In this way, once a purchase offer has been accepted, a buyer may transfer payment for the motor vehicle to the seller through the payment interface.

Preferably, the online motor vehicle sales system further comprises a search interface. It is envisaged that users may be able to access the search interface in order to search current and/or expired sale offers. In a preferred embodiment of the invention, the search interface may allow users to search for sale offers based on one or more criteria (such as make and/or model of motor vehicle, age of motor vehicle, location of motor vehicle etc.). In this way, users may search for (and optionally make a purchase offer for) a motor vehicle for which the sale offer was initially ignored, but about which the user has changed their mind. Similarly, a user may search for a motor vehicle which may fall outside their usual interests (and for which, therefore, a sale offer may not have been received depending on any sale offer filters that the user has set up). Still further, a user may make use of the search interface to determine what other motor vehicles of similar make, model and/or age to a motor vehicle for which a sale offer has issued have sold for previously to establish a suitable purchase price.

In another aspect, the invention resides broadly in an online motor vehicle sales system including at least one computational device configured to:
Receive a motor vehicle sale offer from a seller, the motor vehicle sale offer including information received from two or more external electronic databases in electronic communication with the online motor vehicle sales system;
Maintain an electronic database of one or more buyers;
Send the motor vehicle sale offer to at least one of the one or more buyers;
Receive a purchase offer from at least one of the buyers to whom the motor vehicle sale offer was sent;
Accept a preferred purchase offer; and
Send a notification regarding the acceptance of the preferred purchase offer to the buyer who made the preferred purchase offer.

In another aspect, the invention resides broadly in an online motor vehicle sales method including at least one server, the method including the steps of:
(a) Generating, with an online motor vehicle sales system, a motor vehicle sale offer from a seller, the motor vehicle sale offer being generated by:
   i. entering two or more pieces of information relating to a motor vehicle into the online motor vehicle sales system;
   ii. sending, with the online motor vehicle sales system, one of the one or more pieces of information to a first external electronic database;
   iii. receiving, from the first external electronic database with the online motor vehicle sales system, one or more further pieces of information relating to the motor vehicle;
   iv. Sending, with the online motor vehicle sales system, the one or more further pieces of information to a second external electronic database;
   v. receiving, from the second external electronic database with the online motor vehicle sales system, one or more additional pieces of information relating to the motor vehicle;
   vi, checking, using the online motor vehicle sales system, that the one or more further pieces of information and the one or more additional pieces of information relate to the same motor vehicle as the two or more pieces of information;
   vii. populating, with the online motor vehicle sales system, the sale offer with the two or more pieces of information, the one or more further pieces of information and the one or more additional pieces of information;
(b) Maintaining an electronic database of one or more buyers in association with the online motor vehicle sales system;
(c) Sending, with the online motor vehicle sales system, the motor vehicle sale offer to at least one of the one or more buyers;
(d) Receiving, with the online motor vehicle sales system, a purchase offer from at least one of the buyers to whom the motor vehicle sale offer was sent;
(e) Accepting, with the online motor vehicle sales system, a preferred purchase offer; and
(f) Sending, with the online motor vehicle sales system, a notification regarding the acceptance of the preferred purchase offer to the buyer who made the preferred purchase offer.

It is envisaged that the term “motor vehicle” may be used to describe any suitable motor vehicle. For instance, the term “motor vehicle” may include cars, trucks, buses, motorcycles, boats, aircraft, agricultural vehicles, vehicles used in mining, road-making, construction, trains and the like. While the present invention is described primarily in terms of motor vehicles, it will also be understood that the invention could equally apply to vehicles such as bicycles.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIGS. 1 to 4 illustrate steps in the registration of a user with an online motor vehicle sales system according to an embodiment of the present invention.

FIGS. 5 and 6 illustrate user interfaces of an online motor vehicle sales system according to an embodiment of the present invention.

FIGS. 7 to 11 illustrate steps in the purchase of a motor vehicle using an online motor vehicle sales system according to an embodiment of the present invention.

FIG. 12 illustrates a user interface of an online motor vehicle sales system according to an embodiment of the present invention.

FIGS. 13 and 14 illustrate auction interfaces of an online motor vehicle sales system according to an embodiment of the present invention.

FIGS. 15 to 27 illustrate steps in the generation of a sale offer using an online motor vehicle sales system according to an embodiment of the present invention.

FIGS. 28 to 37 illustrate auction interfaces of an online motor vehicle sales system according to an embodiment of the present invention.

FIG. 38 illustrates user interfaces of an online motor vehicle sales system according to an embodiment of the present invention.

FIGS. 39 to 42 illustrate network interfaces of an online motor vehicle sales system according to an embodiment of the present invention.

FIGS. 42 and 44 illustrate user interfaces of an online motor vehicle sales system according to an embodiment of the present invention.

FIG. 45 is a schematic diagram of an online motor vehicle sales system according to an embodiment of the present invention.

### DESCRIPTION OF EMBODIMENTS

In the Figures illustrated in the present application, a view of both the mobile device interface as well as the laptop/desktop computer interface of the online motor vehicle sales system is illustrated. The mobile device interface is shown at the left of each relevant Figure, while the laptop/desktop computer interface is shown at the right of each relevant Figure.

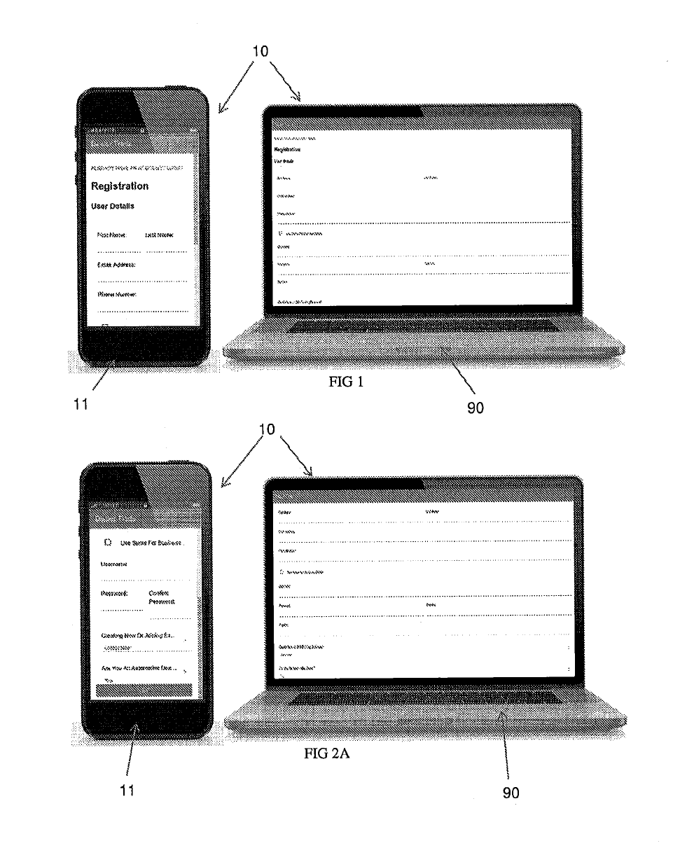

In FIGS. 1 to 4 there are illustrated steps in the registration of a user with an online motor vehicle sales system 10 according to an embodiment of the present invention. In the embodiment of the invention illustrated in FIGS. 1 to 4, the online motor vehicle sales system 10 is accessed by a user using an electronic device in the form of a mobile telephone 11 or laptop computer 90.

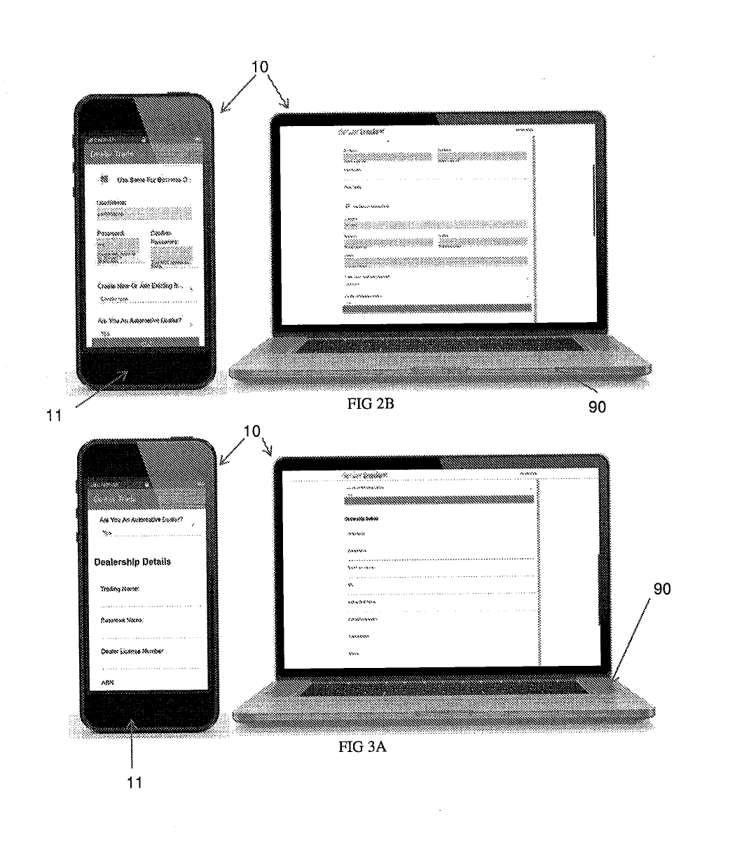

In FIG. 1, a user registers to access the online motor vehicle sales system 10 by entering their personal details (including their name, email address and phone number) into a registration interface. In FIGS. 2A and 2B, the user then enters their account details (including user name, password and whether the user is a registered motor vehicle dealer). In addition, the user must select whether they are registering a new account or whether their registration will be associated with an existing registration for a motor vehicle dealership.

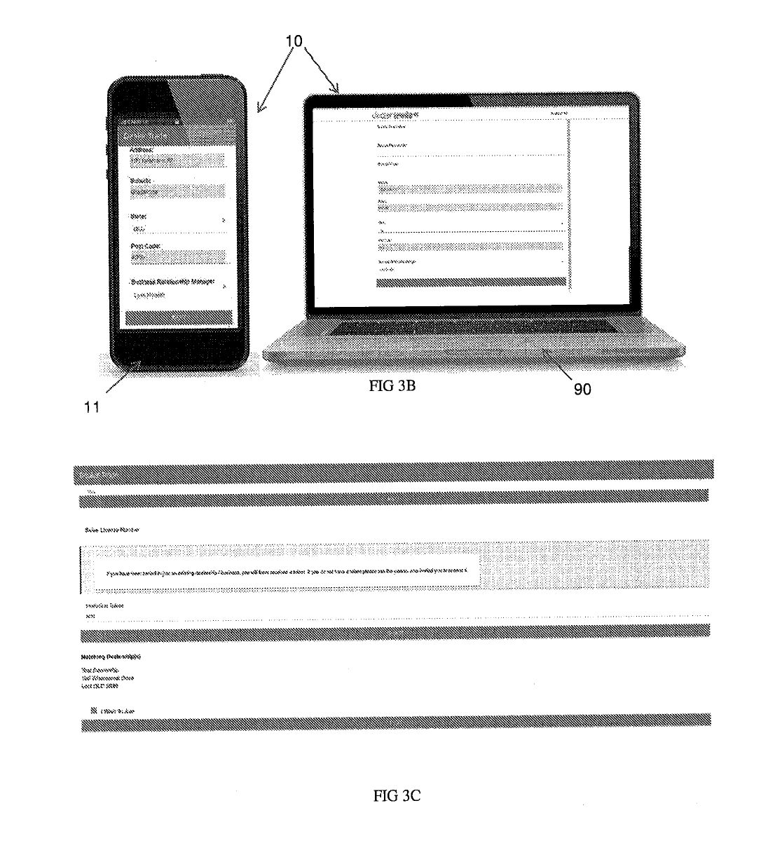

If the user chooses that their registration will be associated with an existing registration for a motor vehicle dealership, the online motor vehicle sales system 10 will prompt the user to enter the dealership details (trading name, business name, dealer licence number, address, business relationship manager name etc.) into the registration interface as illustrated in FIGS. 3A and 3B.

The user may either request to join an existing dealership or may be invited to join an existing dealership (by a member of the dealership). If the user is invited to join the dealership, it is envisaged that the user will receive an invitation from the dealership and that the invitation will include a token (a code, password or the like) that the user will enter into the registration interface in order to verify that they have been invited to join the existing dealership registration. This is illustrated in FIG. 3C.

The online motor vehicle sales system 10 then consults an external electronic database operated by the government agency that issues motor vehicle dealer licences to determine whether the user registration is valid.

If the online motor vehicle sales system 10 determines that the user's registration is valid, the online motor vehicle sales system 10 will electronically issue a verification code to the user (for instance, by text message or email message).

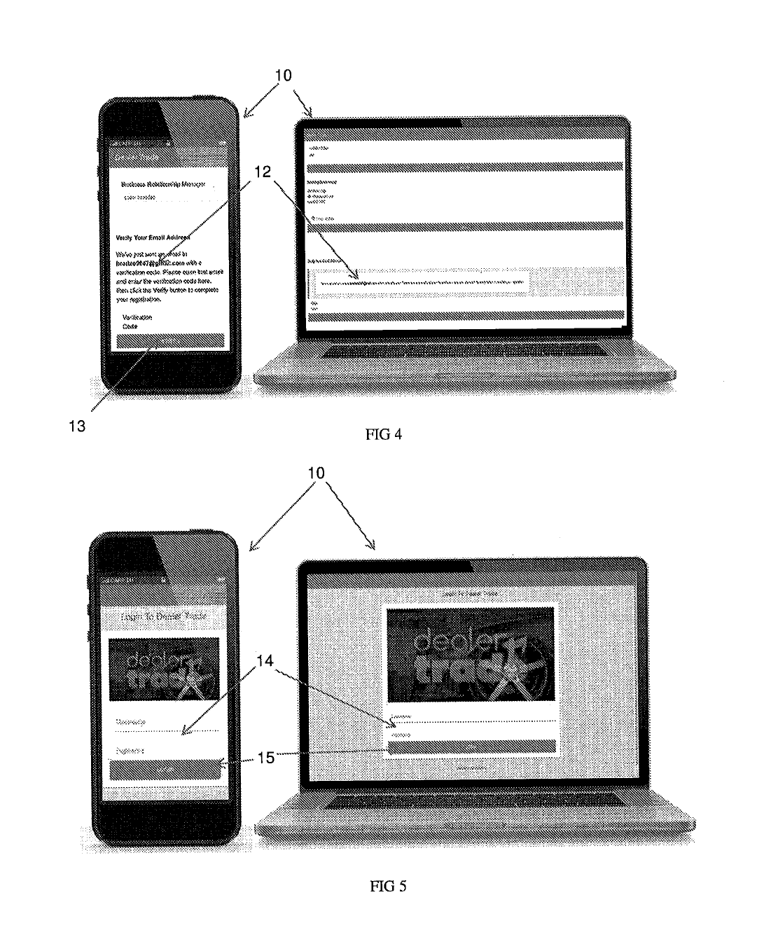

In order for the user to complete their registration, the user must access the online motor vehicle sales system 10 where the registration interface 12 illustrated in FIG. 4 will request the input of the verification code. Upon entry of the verification code into the registration interface 12, the user presses a button 13. Once the button 13 is pressed, the online motor vehicle sales system 10 will verify that the verification code matches the user's registration details. If the registration details and the verification code matches, the online motor vehicle sales system 10 will display a confirmation message to confirm that the user now has access to the online motor vehicle sales system 10.

Once a user is registered, the user may access the online motor vehicle sales system 10 via a login interface 14 as illustrated in FIG. 5. The user enters their username and password into the login interface and then presses the login button 15 in order to access the online motor vehicle sales system 10.

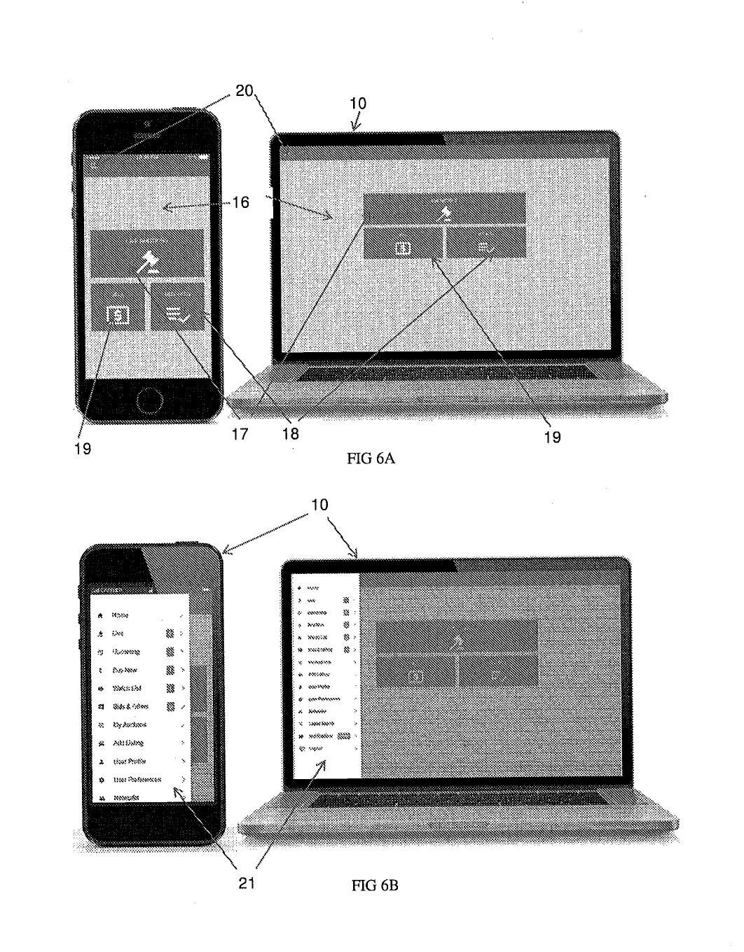

In FIG. 6A there is illustrated a user interface 16 of an online motor vehicle sales system 10 according to an embodiment of the present invention. In the user interface 16, a user may perform a number of actions by pressing buttons provided on the user interface 16. For instance, a user may search live auctions by pressing the “Live Auctions” button 17, may search motor vehicles for sale by pressing the “Buy Now” button 18, or may enter the sale offer interface by pressing the “Sell” button 19.

The online motor vehicle sales system 10 includes a menu button 20 that, when pressed, allows a user to access a menu interface 21 shown in FIG. 6B.

The user interface enables the user to obtain information about the vehicles, including technical details relating to the vehicles generally, details specific to the vehicles being sold, and access to images of the vehicles. The user interface may include various tools enabling the user to access this data, including a zoom function, which enables the user to zoom in on images to obtain close-up images of the vehicles.

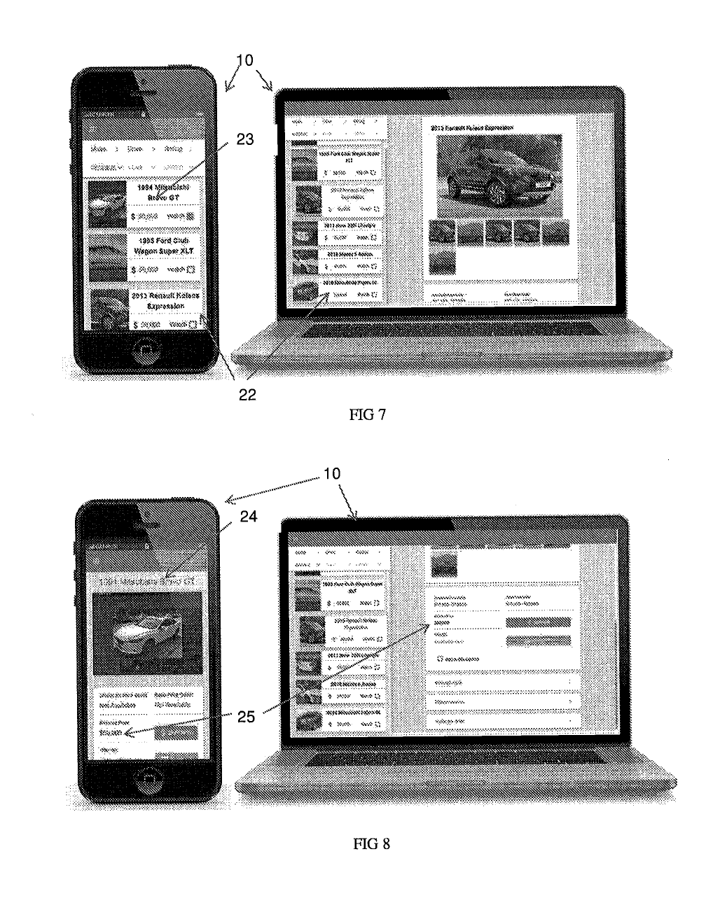

FIGS. 7 to 11 illustrate steps in the purchase of a motor vehicle using the online motor vehicle sales system 10 according to an embodiment of the present invention. In FIG. 7, the user has pressed the “Buy Now” button 18 illustrated in FIG. 6A to access a list 22 of vehicles that are currently for sale. If the user wishes to buy a particular vehicle, the user presses the vehicle listing 23 of interest to access a detailed vehicle listing 24 as illustrated in FIG. 8. The user can then either choose to buy the vehicle for the reserve price 25 set by the seller in the detailed vehicle listing 24, or may make an offer to buy the vehicle by entering a price at which the user wishes to buy the vehicle, the price typically being below the reserve price 25.

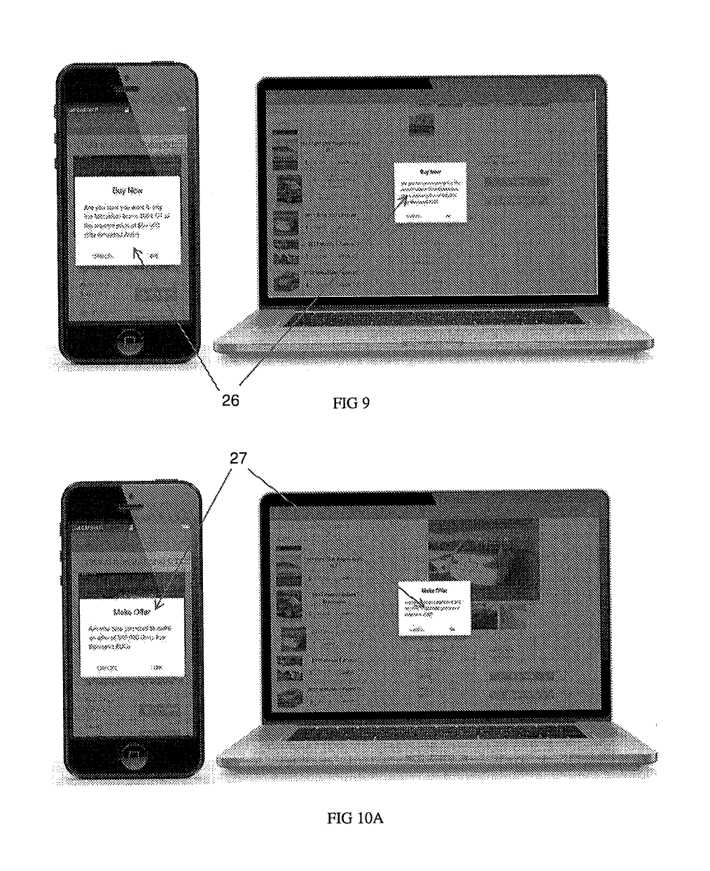

If the user elects to buy the vehicle for the reserve price 25, a confirmation screen 26 26 as illustrated in FIG. 9 is generated. The user then either confirms their purchase of the vehicle for the reserve price 25 or cancels the transaction.

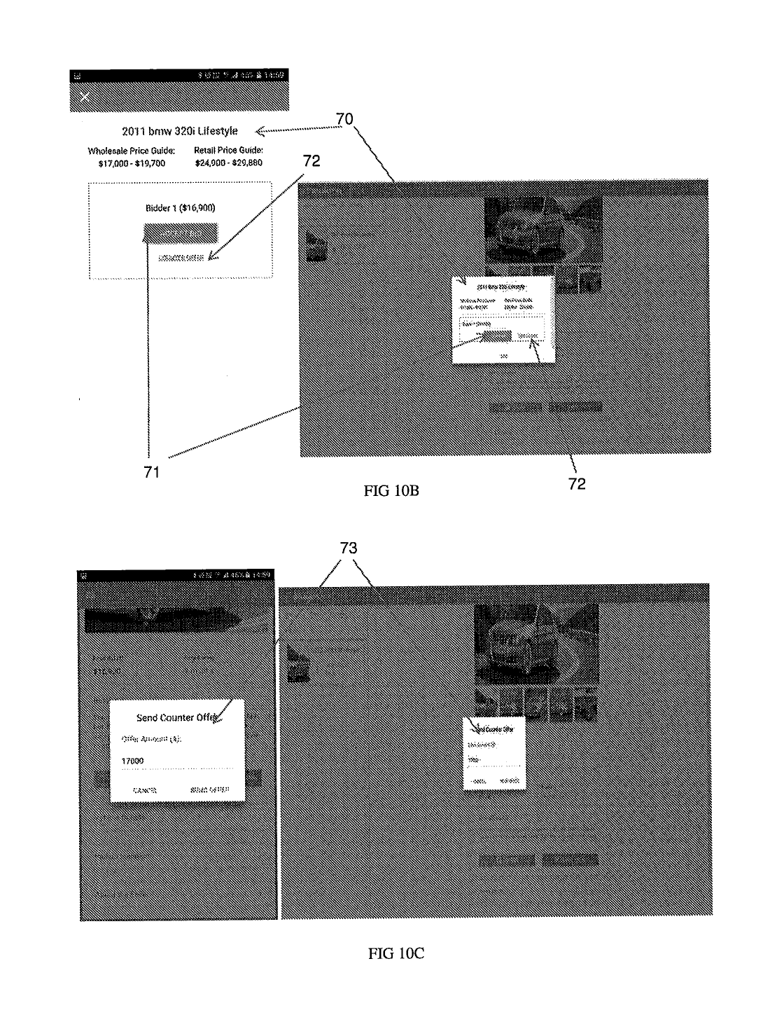

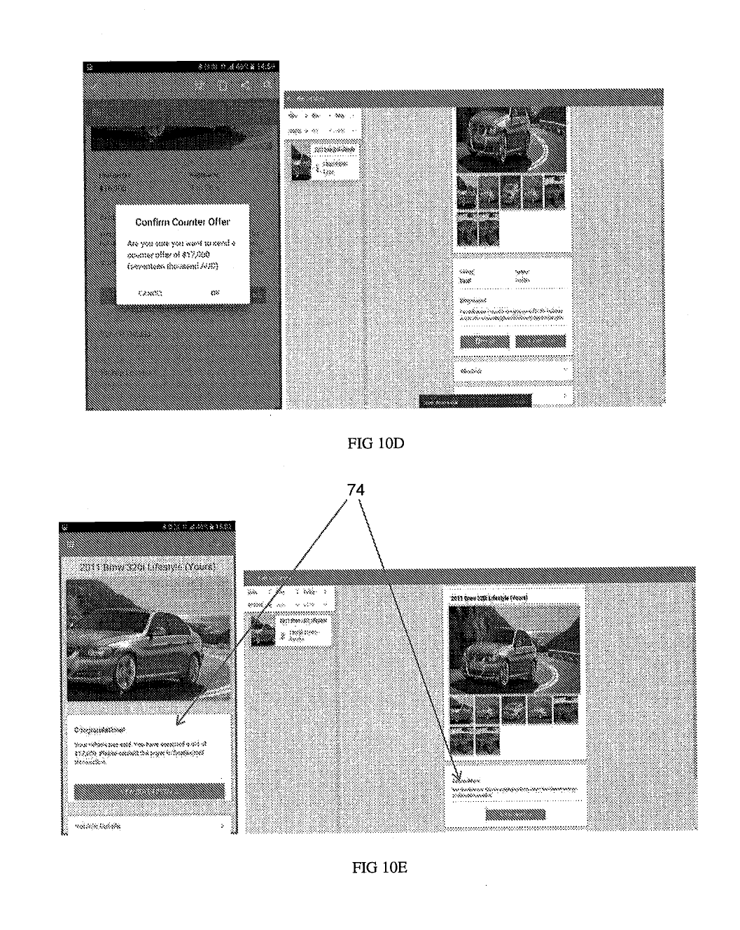

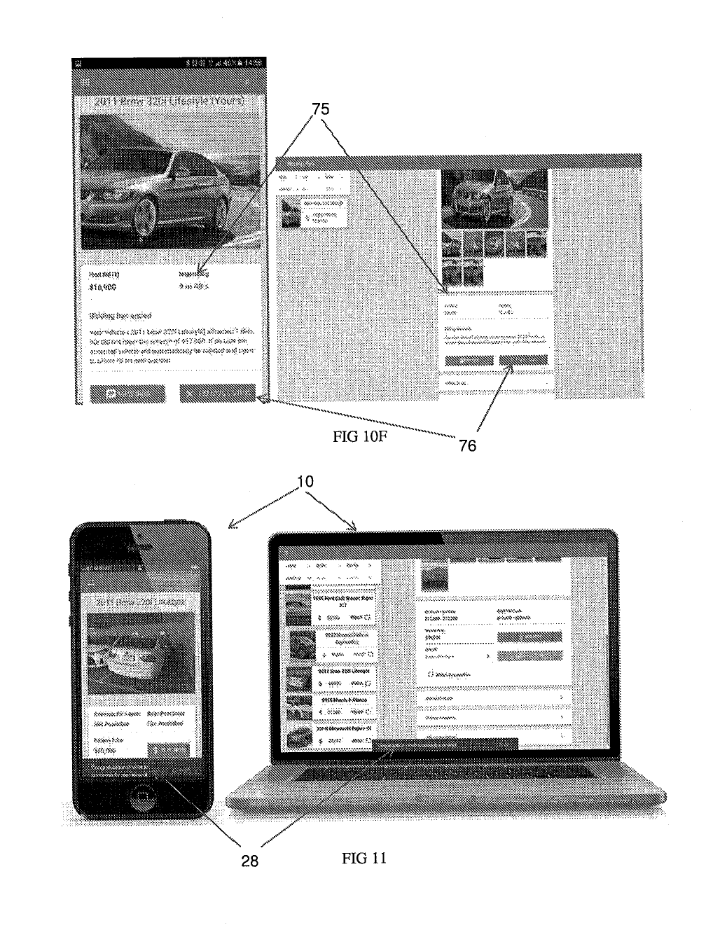

If the user makes an offer to buy the vehicle at a price other than the reserve price 25, a confirmation screen 27 as illustrated in FIG. 10A is generated. The user then either confirms their offer to purchase the vehicle for the offer price or cancels the transaction. If the user confirms their offer, the seller will then be provided with an opportunity to either accept or decline the offer. Alternatively, the seller may be able to send a counter-offer to the buyer which the buyer may then decline or accept.

In FIG. 10B there is illustrated an offer screen 70 that is displayed to the seller when a user offers to buy a vehicle at a price below the reserve price. The seller may elect either to accept the offer by pressing button 71 or may send a counter-offer by pressing button 72.

If the seller elects to send a counter-offer, a counter-offer screen 73 as illustrated in FIG. 10C is generated. The counter-offer screen 73 allows the seller to enter a counter-offer price and send it to the buyer. Typically, the counter-offer price will be between the buyer's offer price and the reserve price. The seller will be provided with an opportunity to confirm that the counter-offer should be sent to the buyer, as illustrated in FIG. 10D.

If the buyer choose to accept the counter-offer, the seller will be provided with a confirmation screen 74 as illustrated in FIG. 10E confirming that the buyer has accepted the counter-offer and the vehicle has been sold.

If the buyer declines the counter-offer, or if no bids matching the reserve price are received by the time the sale offer expires, the seller is provided with a sale offer concluded screen 75 as illustrated in FIG. 10F. It is envisaged that the sale offer will be automatically relisted by the online motor vehicle sales system, although the user may also remove the listing from the online motor vehicle sales system by pressing button 76.

When the sale offer comprises an auction, and the highest bid is below the seller's reserve, a counter-offer, as outlined above, may be made to the highest bidder (or several bidders). This enables the seller and bidder(s) to negotiate a sale post auction.

If the user successfully purchase the vehicle (either at the reserve price, or has their offer accepted by the seller), the online motor vehicle sales system 10 generates and displays a confirmation message 28 confirming the user's purchase of the vehicle as illustrated in FIG. 11.

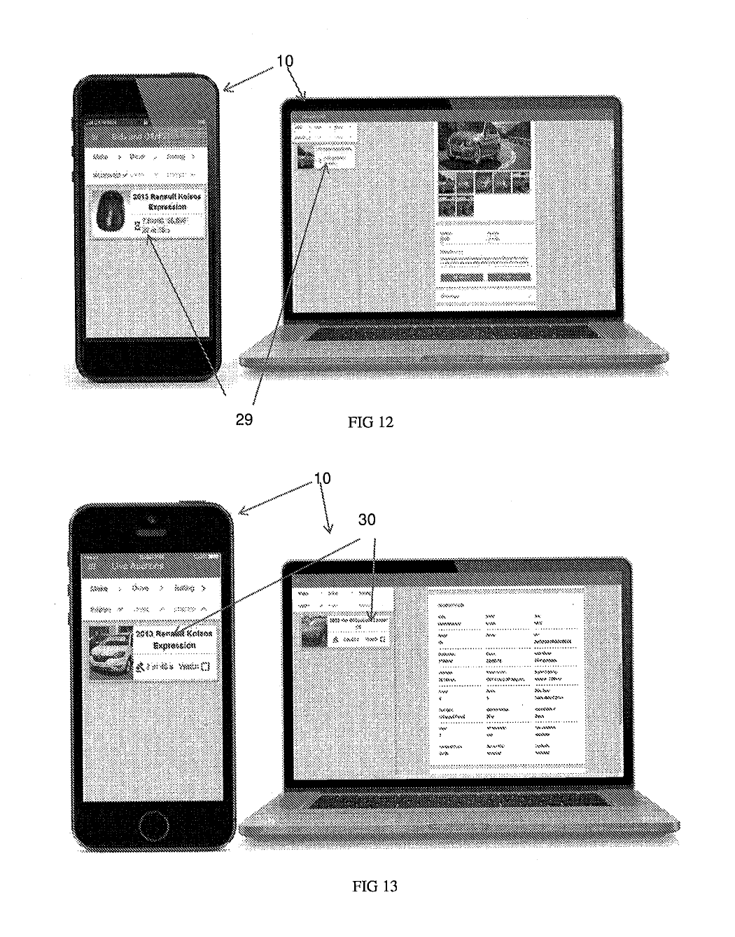

The online motor vehicle sales system 10 also comprises a bids and offers interface 29 as illustrated in FIG. 12 in which are listed all of a user's current auctions bids and purchase offers. This interface 29 allows a user to track all of the vehicles of current interest.

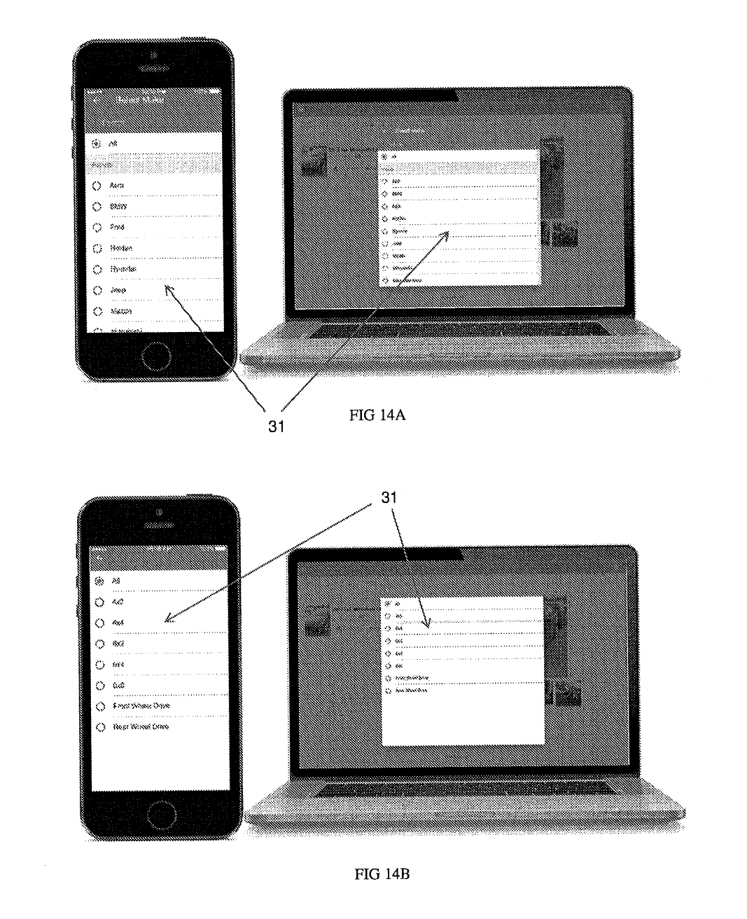

FIG. 13 illustrates an auction interface 30 in which are listed all of the current live auctions in the online motor vehicle sales system 10. A user is able to search for live auction listings of particular interest using the live auction search interfaces 31 illustrated in FIGS. 14A and 14B. In FIG. 14A, the live auction search interface 31 allows a user to filter live auctions based on the make of the vehicle, while in FIG. 14B the live auction search interface 31 allows a user to filer live auctions based on the drive type of the vehicle.

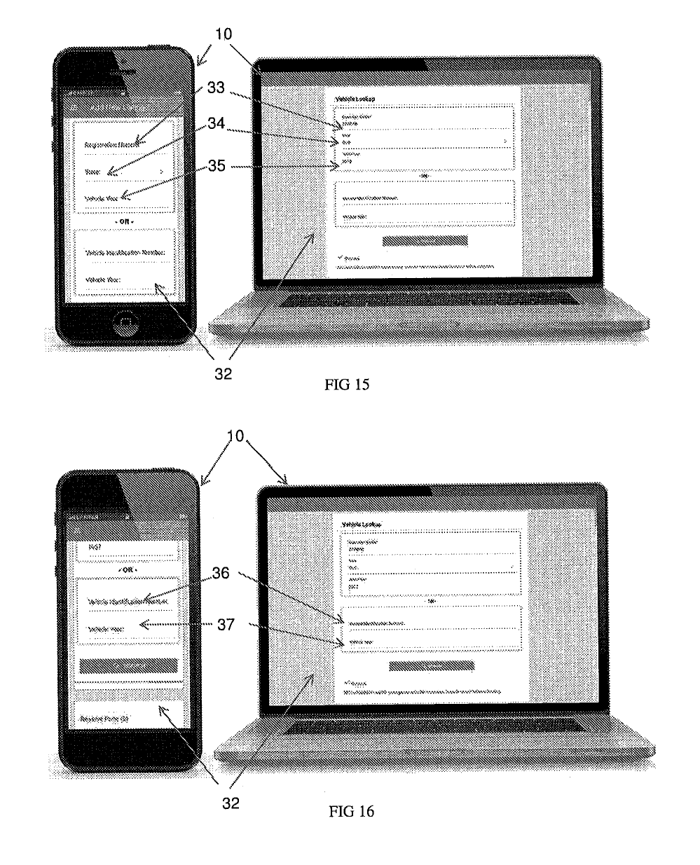

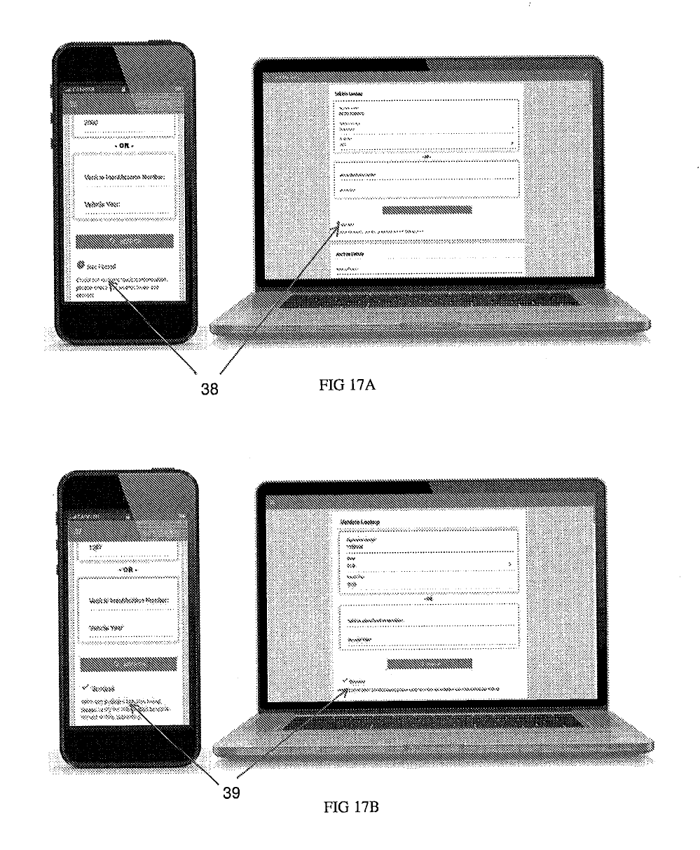

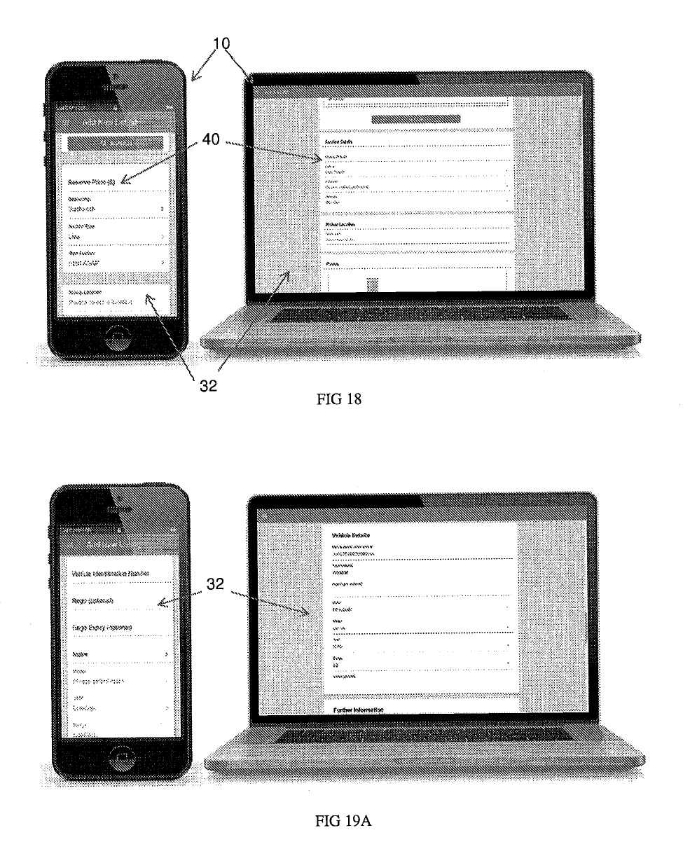

FIGS. 15 and 16 illustrate a sale offer interface 32 of an online motor vehicle sales system 10 according to an embodiment of the present invention. The user enters the registration number 33, the state/province/country of registration 34 and the year of manufacture 35 into the sale offer interface 32 and then submits these details to the online motor vehicle sales system database. Alternatively, as illustrated in FIG. 16, the user may enter the Vehicle Identification Number (VIN) 36 and year of manufacture 37 into the sale offer interface 32. If the user enters the registration number 33 into the sale offer interface, the online motor vehicle sales system database consults a first external electronic database of vehicle registration information (such as a government database) to obtain information regarding the motor vehicle for sale (such as the vehicle's VIN). Once this information is received, the online motor vehicle sales system database uses this information to consult a second external electronic database of vehicle registration information to obtain further information regarding the vehicle (such as the vehicle's National Vehicle Identification Number (NVIC)). Once this information is received, the online motor vehicle sales system database uses this information to consult a third external electronic database of vehicle registration information to obtain further information regarding the vehicle (such as the manufacture information, vehicle information, price guide, engine information, rating information and warranty and service periods).

In embodiments of the invention in which the user enters the VIN into the sale offer interface 32, the online motor vehicle sales system database consults a first external electronic database of vehicle registration information (such as a government database) to obtain information regarding the motor vehicle for sale (such as the vehicle's registration number). Alternatively, the online motor vehicle sales system database may consult the other external electronic databases to determine the NVIC and the other vehicle information.

In either situation, if the information obtained from the external electronic databases does not match the information entered by the user, the online motor vehicle sales system 10 will generate a warning 38 as illustrated in FIG. 17A to alert a user to the fact that there is non-matching information and prevent the user from completing the sale offer. Alternatively, if the information entered by the user matches the information obtained from the external electronic databases, the online motor vehicle sales system 10 may then automatically populate the sale offer interface 32 with this information and provide an alert 39 to the user confirming that the sale offer has been successfully populated with information.

Once the sale offer interface 32 is populated, the user may then select whether the sale offer is to be an immediate or scheduled sale or auction, whether the sale offer is to be offered only to a specific group or network within the online motor vehicle sales system 10, or whether the sale offer is to be a part of a scheduled auction (for instance, held at a predetermined time on a particular day or days of the week, such as a Tuesday and Thursday). The user may also enter a reserve price 40 into the sale offer interface 32.

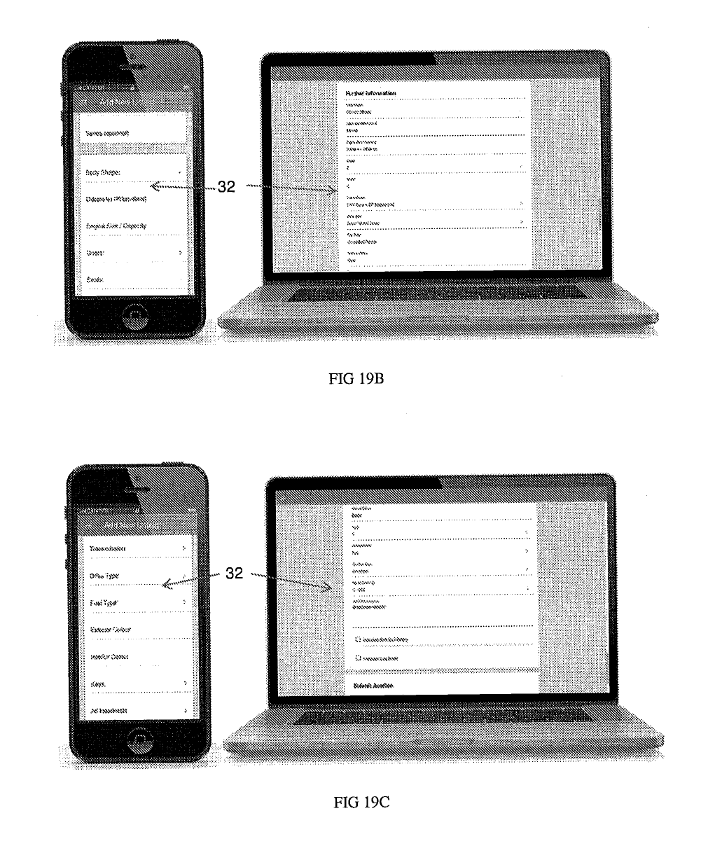

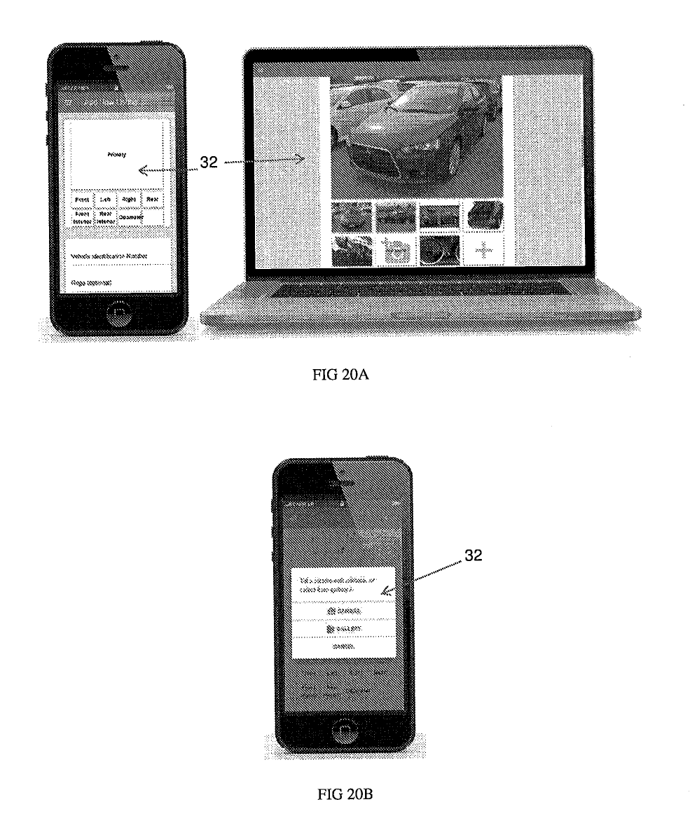

Once the sale offer interface 32 has been populated with information received from the two or more external electronic databases, the user may then customise the sale offer by entering additional information into the sale offer interface 32 as illustrated in FIGS. 19A, 19B and 19C. Alternatively, the user may check or alter the automatically populated information in the sale offer interface 32 if required. The user may also upload photos of the motor vehicle to the sale offer interface 32 as illustrated in FIGS. 20A and 20B.

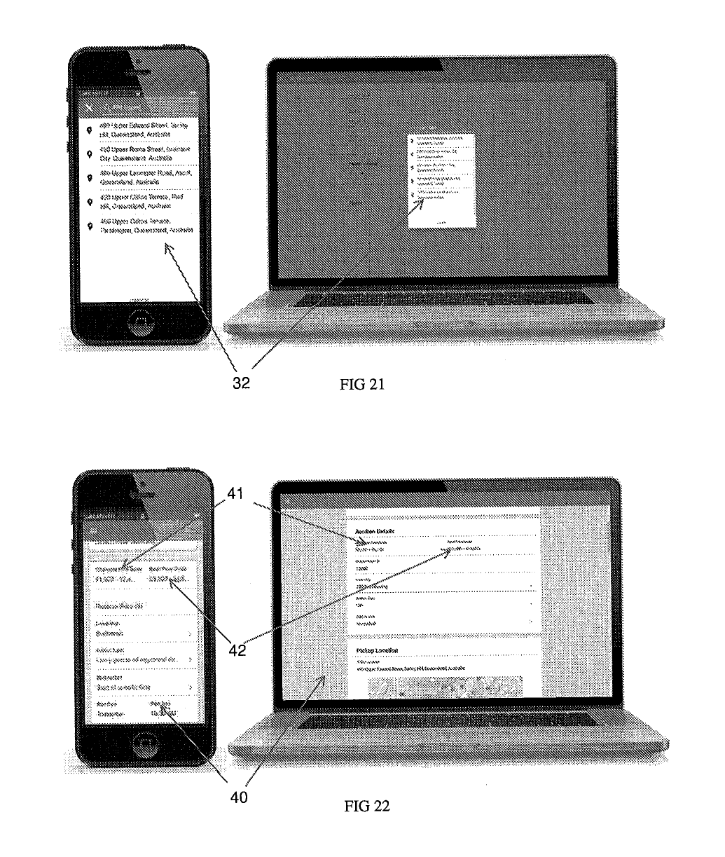

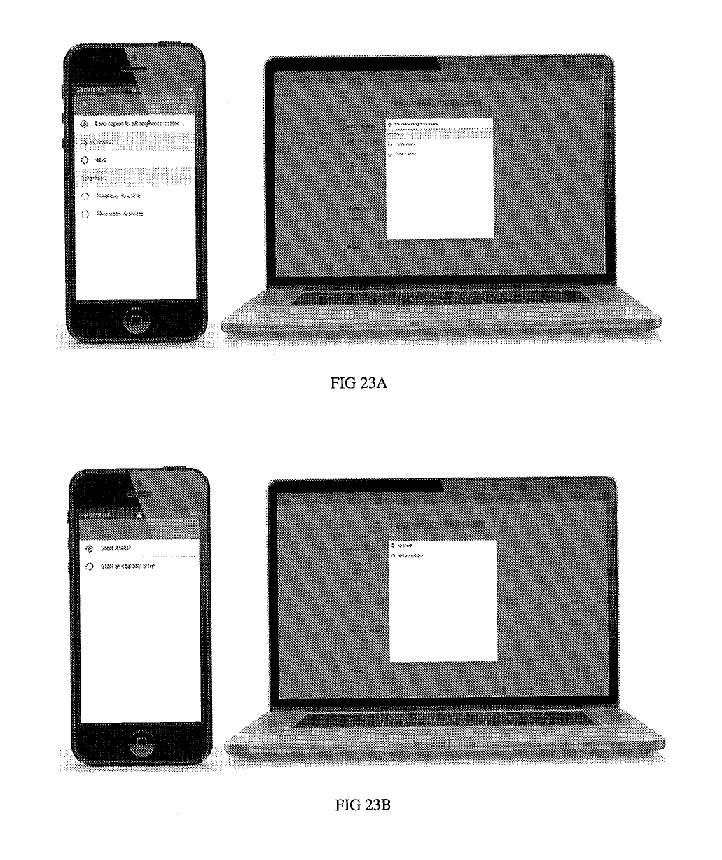

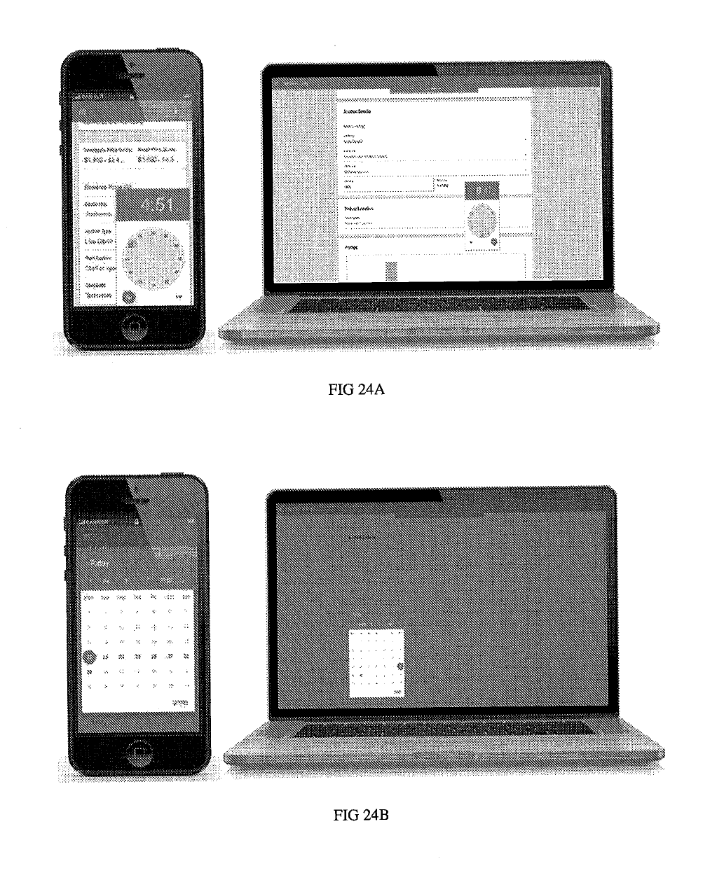

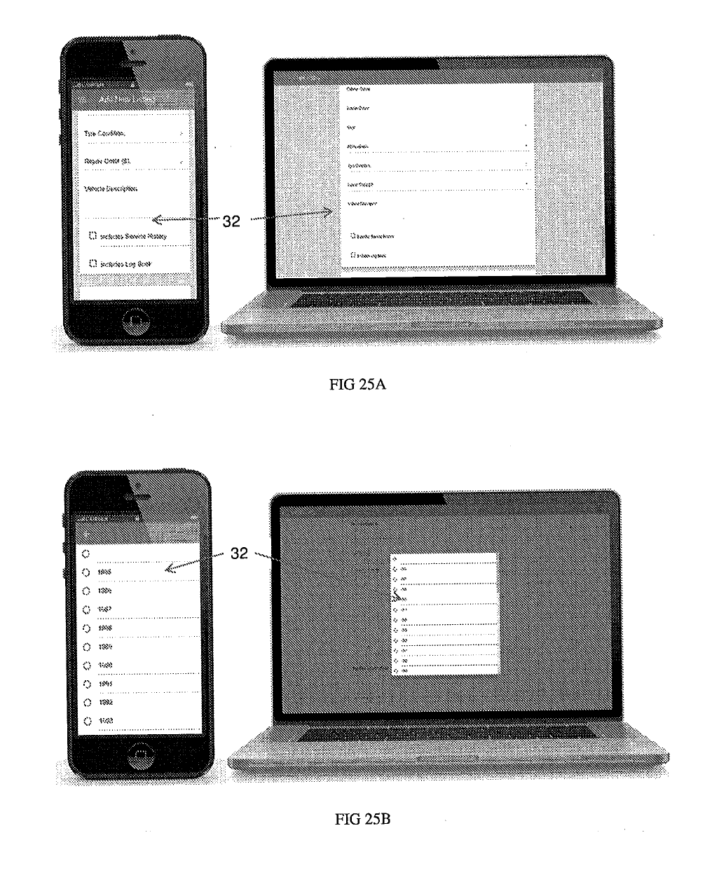

In FIG. 21, the user may enter the pickup address of the vehicle into the sale offer interface 32, while in FIG. 22, the online motor vehicle sales system 10 checks the reserve price 40 entered by the user against the wholesale price guide 41 and retail price guide 42 obtained from an external electronic database. If the user's reserve price 40 is within the price guides 41, 42, the reserve price 40 may be shown in green text, while if the user's reserve price 40 is above or below the price guides 41, 42, the reserve price 40 may be shown in red text.

In FIG. 23A, if the sale offer is to be an auction, the user may select whether the auction is open to all users, to a selected group or network, or whether it is to be a scheduled auction on, in the embodiment of the invention shown in FIG. 23A, a Tuesday or Thursday.

If the user selects that the auction is to be open to all users (or to a selected group or network), the user may choose to start the auction immediately or at a specific time as shown in FIG. 23B.

If the user chooses to start the auction at a specific time, the user may select the time and date (as illustrated in FIGS. 24A and 24B, respectively) at which the auction is to commence. In certain embodiments, the user may select an auction length, defining a desired length over which the auction is held.

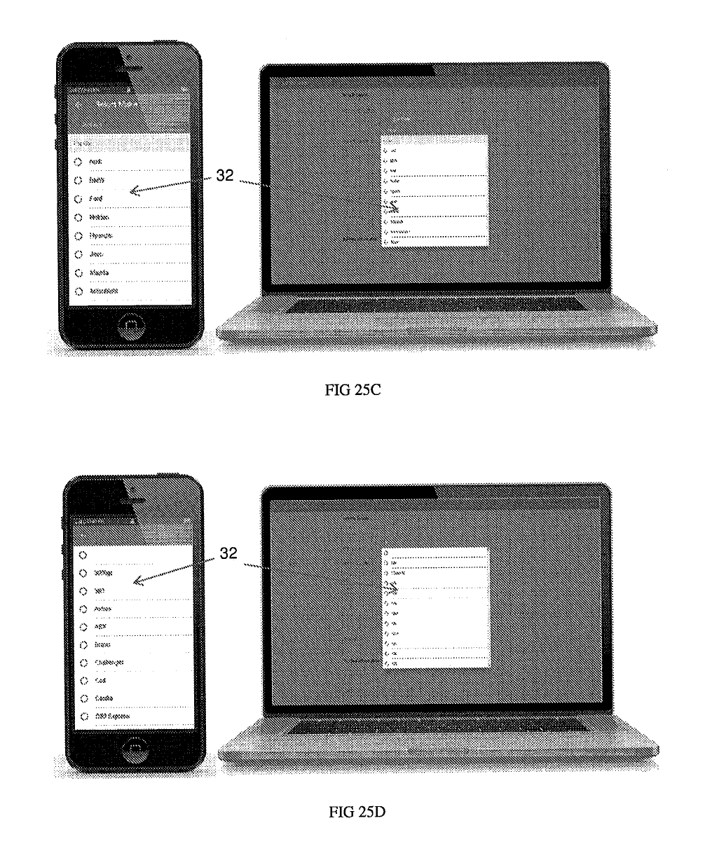

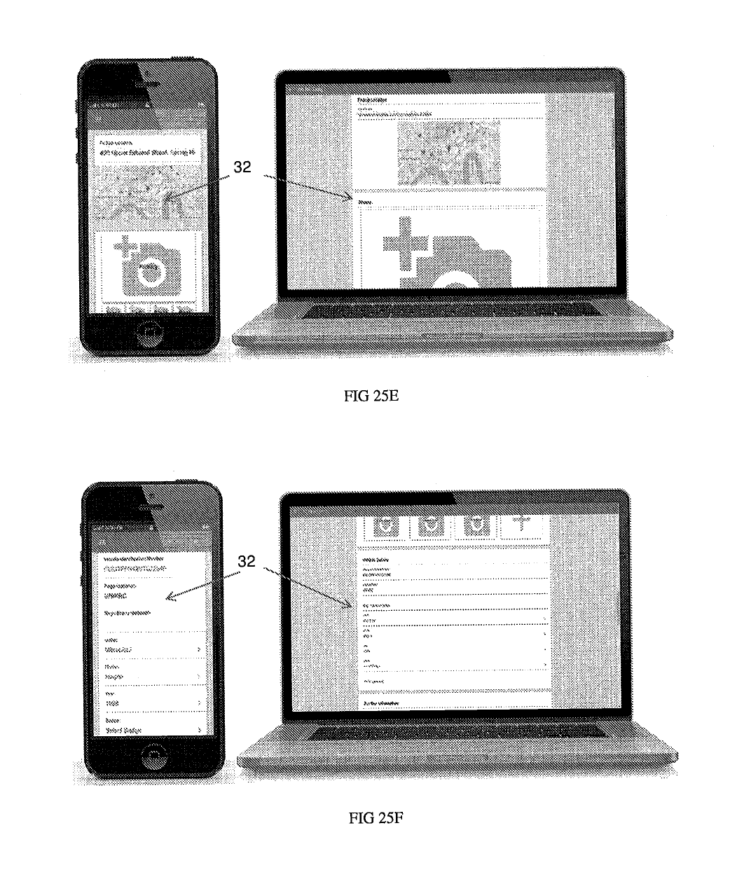

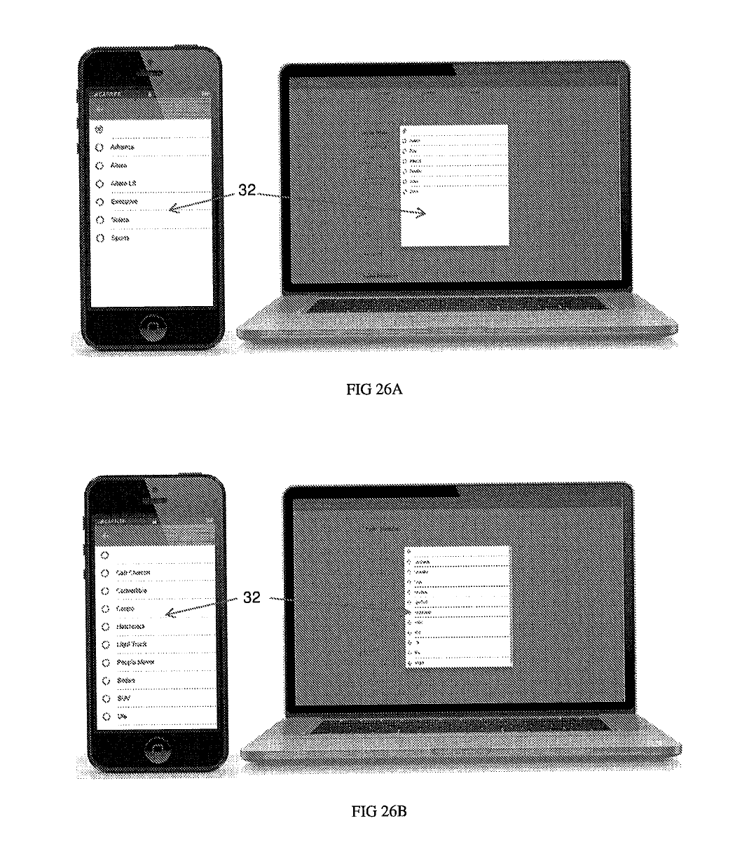

It is envisaged that, in some embodiments, the user may be able to enter, check or edit information in the sale offer interface 32. For instance, in FIG. 25A, the user may upload a vehicle's service history (or confirm that the service history is available) and upload a vehicle's log book (or confirm that the log book is available. In FIG. 25B, the user may select the vehicle's year of manufacture, while in FIGS. 25C and 25D the user may select the make and model (respectively) of the vehicle. In FIGS. 25E and 25F, the user may enter the vehicle's pickup location and details (respectively).

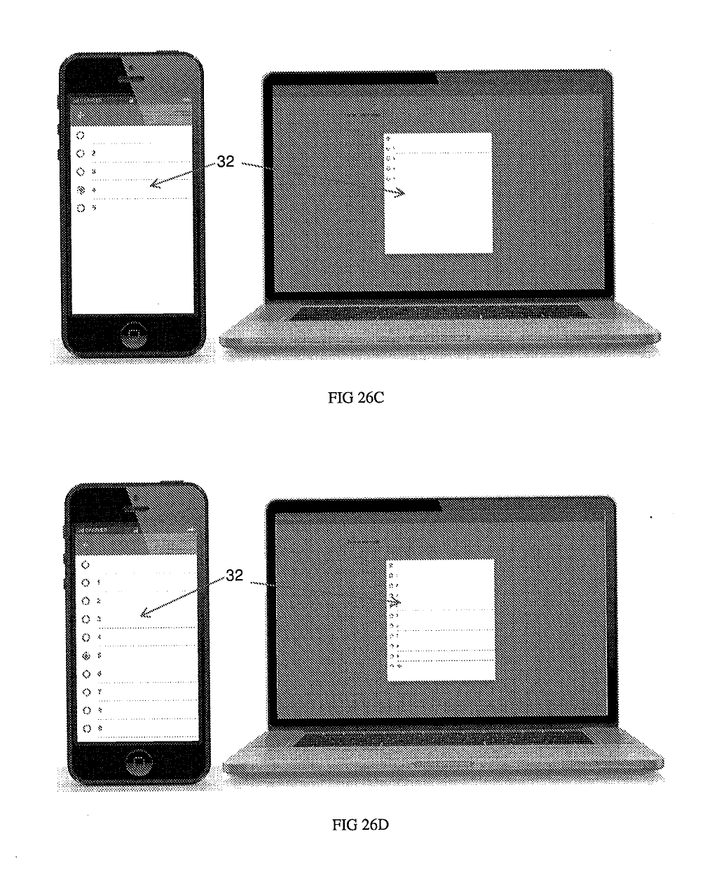

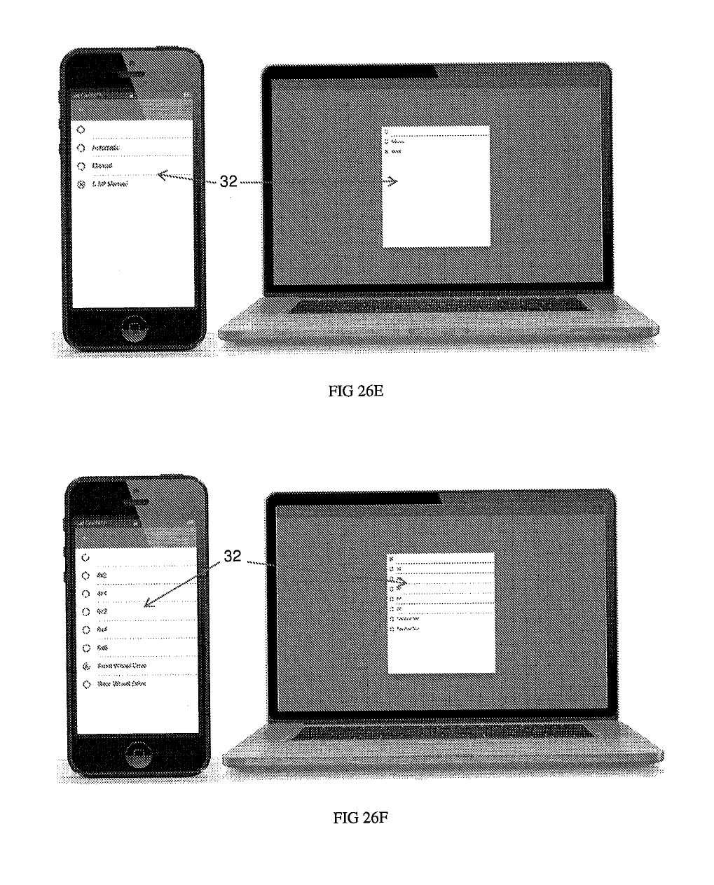

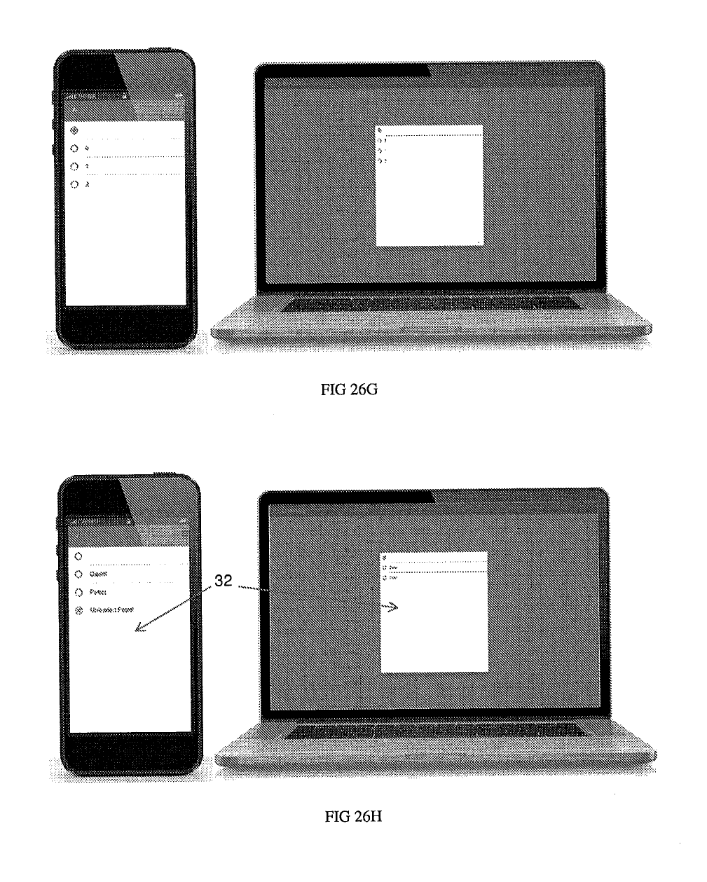

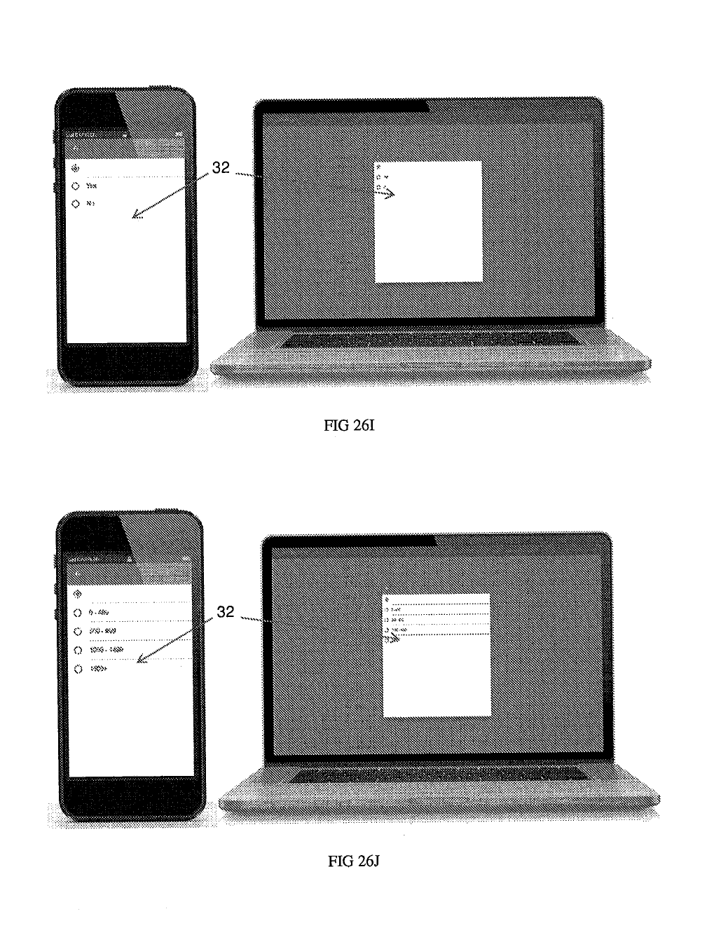

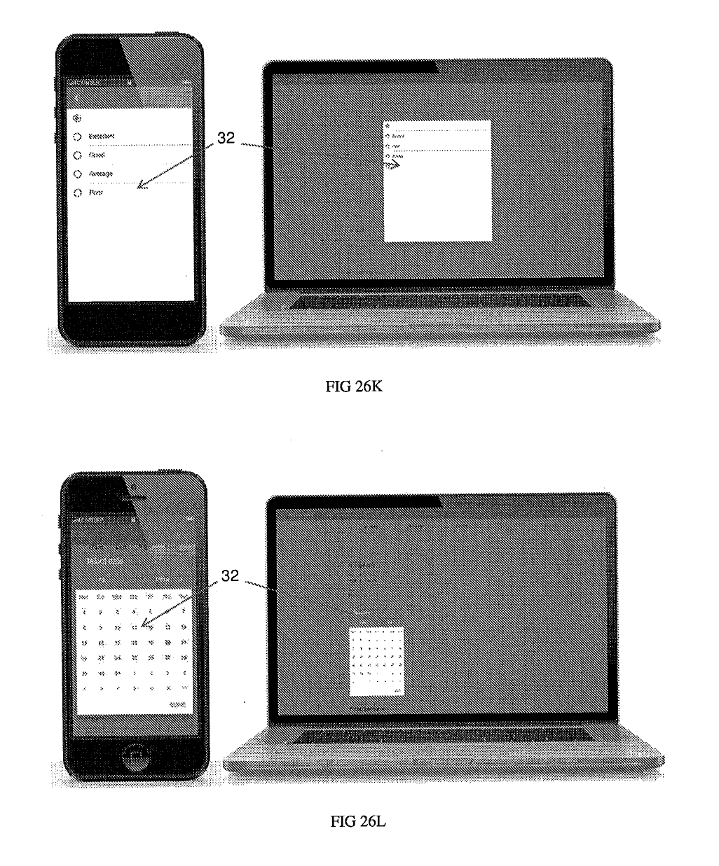

In FIG. 26A, the user may enter the vehicle's badge type into the sale offer interface, while in FIG. 26B the user may enter the vehicle's body type. In FIGS. 26C and 26D the user may select the number of doors and wheels (respectively) the vehicle has.

In FIG. 26E, the user selects the transmission type, while in FIG. 26F, the user selects the drive type. In FIG. 26G the user may select the number of keys associated with the vehicle, while in FIG. 26H the user may select the vehicle's fuel type.

In FIG. 26I the user selects whether headrests are installed in the vehicle, while in FIG. 26J the user selects the average repair costs for the vehicle. Tyre condition is selected in FIG. 26K, while the vehicle's registration expiry date is entered into the sale offer interface 32 in FIG. 26L.

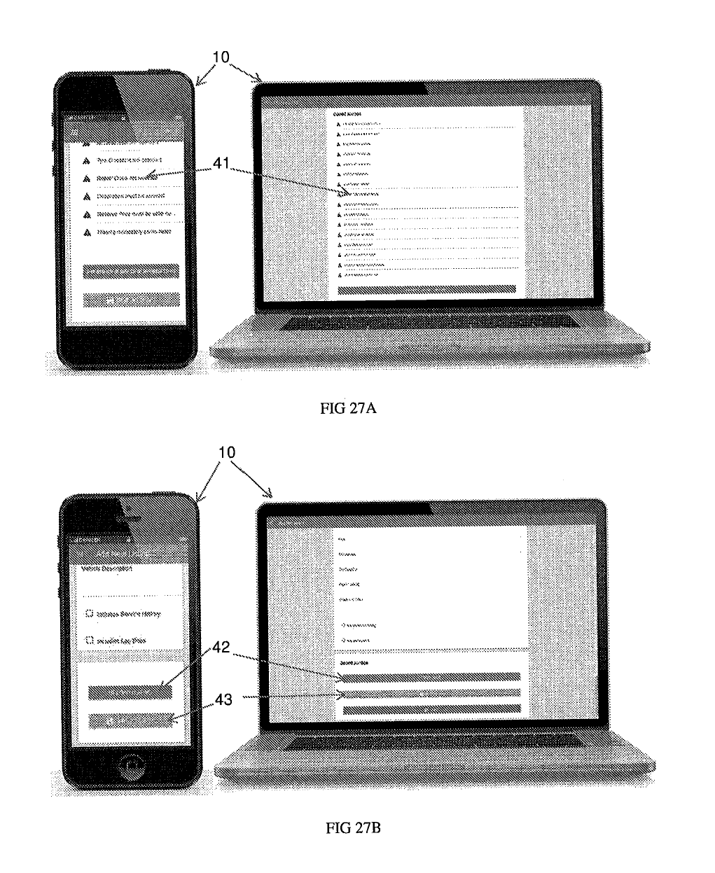

If the sale offer contains any errors, the online motor vehicle sales system 10 generates warnings 41 as illustrated in FIG. 27A to inform the user that information is incorrect or missing. Alternatively, if the sale offer contains no errors, the user may either upload the sale offer to the online motor vehicle sales system 10 using the upload listing button 42, or may save the sale offer as a draft using button 43.

In some embodiments, the system 10 is configured to enable a ‘draft’ of the sale offer to the saved. This enables the seller to save vehicles for auction at a later date or set a future auction time.

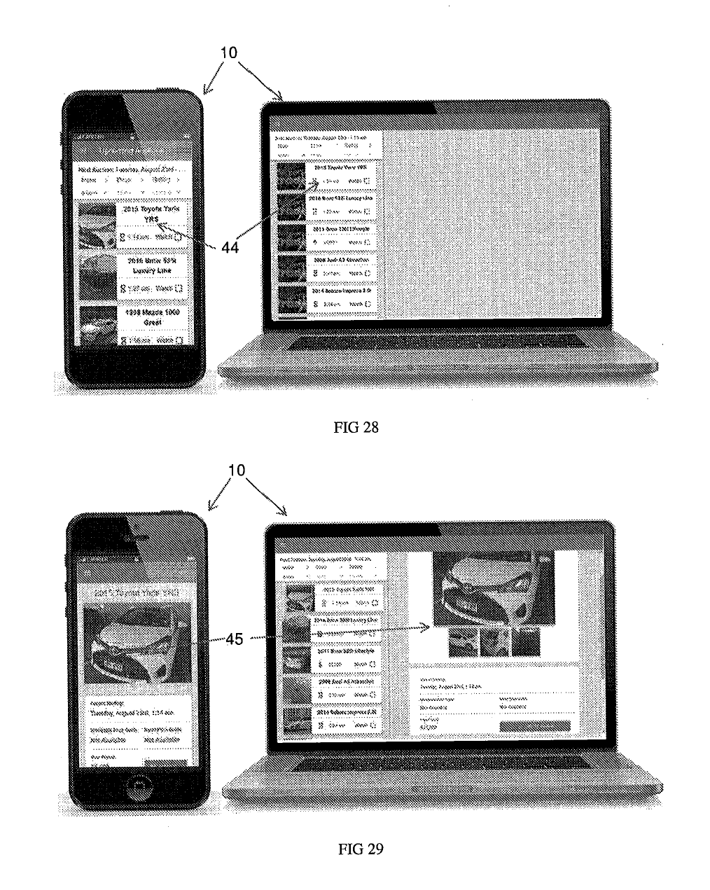

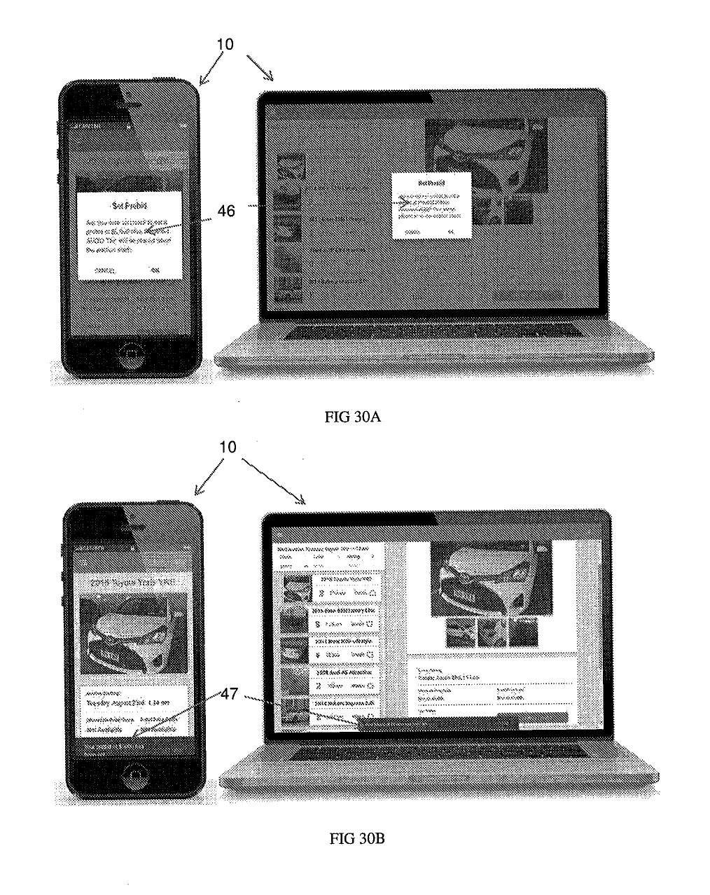

The online motor vehicle sales system 10 allows a user to view a list 44 of scheduled upcoming auctions as illustrated in FIG. 28. A user may select one of the upcoming auctions from the list 44 to see a detailed auction listing 45 (as illustrated in FIG. 29). If the user wishes, they may enter a prebid prior to the commencement of the auction, and the online motor vehicle sales system will generate a confirmation request 46 (as illustrated in FIG. 30A) asking the user to either confirm of cancel their prebid. If the user confirms the prebid, the online motor vehicle sales system 10 will provide a confirmation notice 47 (as shown in FIG. 30B) confirming that the prebid has been made.

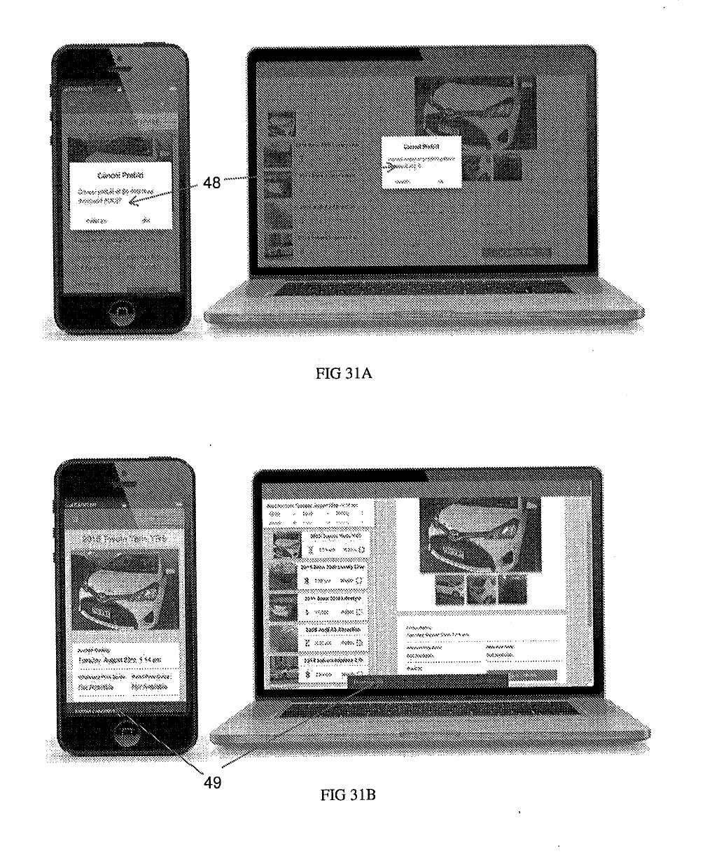

If the user wishes to withdraw the prebid prior to the commencement of the auction, the user may cancel the prebid as shown in the cancellation request 48 in FIG. 31A. If the user confirms the cancellation of the prebid, the online motor vehicle sales system 10 will provide a cancellation notice 49 (as shown in FIG. 31B) confirming that the prebid has been cancelled.

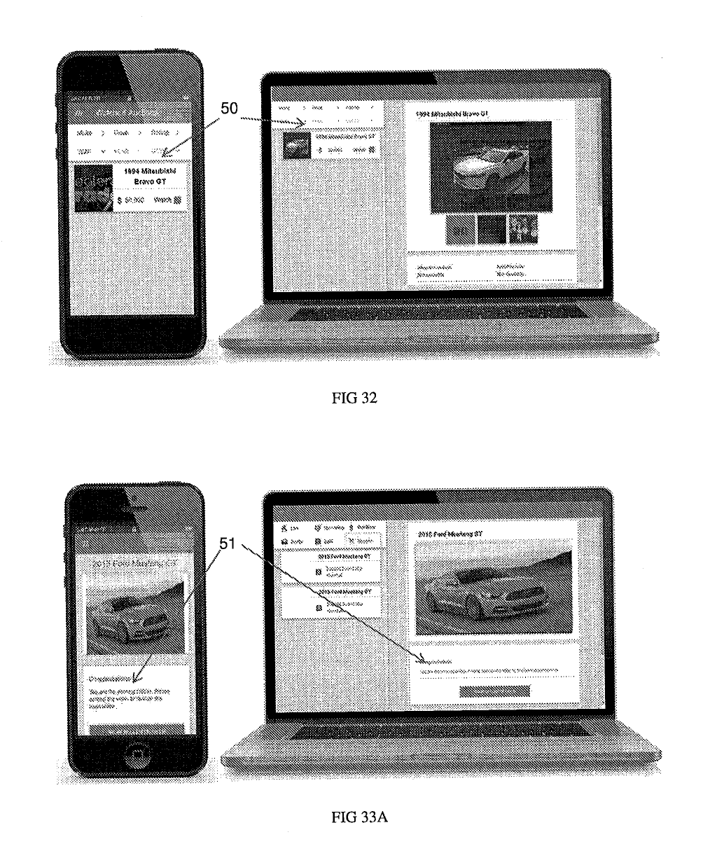

In FIG. 32, a watching interface 50 of the online motor vehicle sales system 10 is illustrated. The watching interface 50 allows a user to track auctioned vehicles that the user has an interest in purchasing.

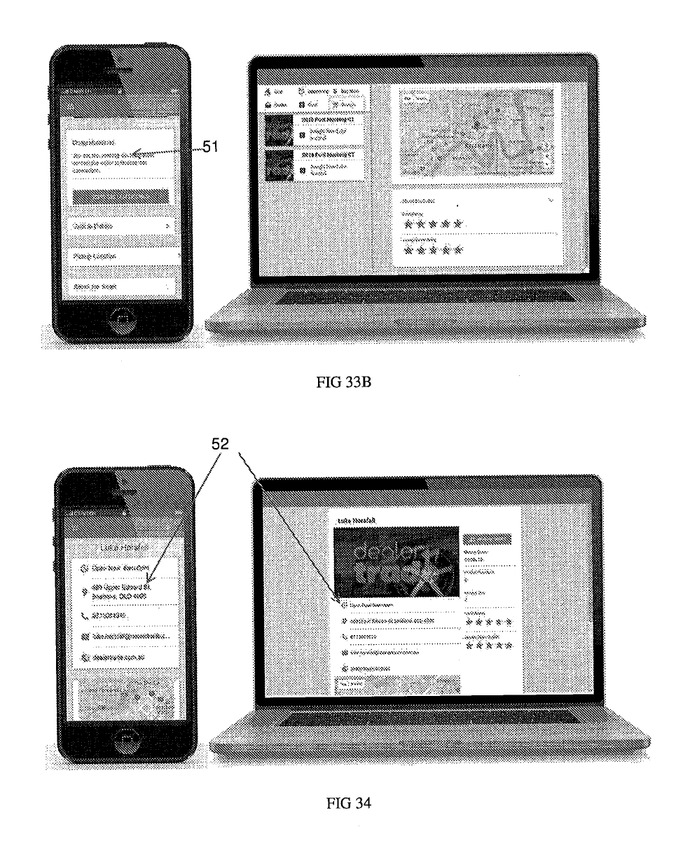

When an auction has been won, the winning buyer is provided with a notification 51 as illustrated in FIGS. 33A and 33B. The winning buyer may then contact the seller to arrange transportation of the vehicle and to make the necessary payments. The buyer may do this by viewing the seller's information 52 as illustrated in FIG. 34.

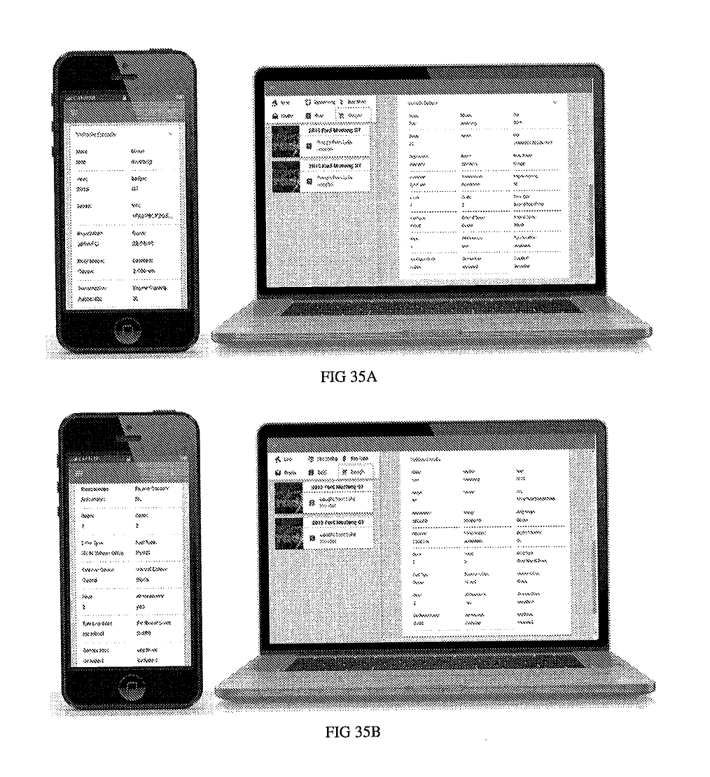

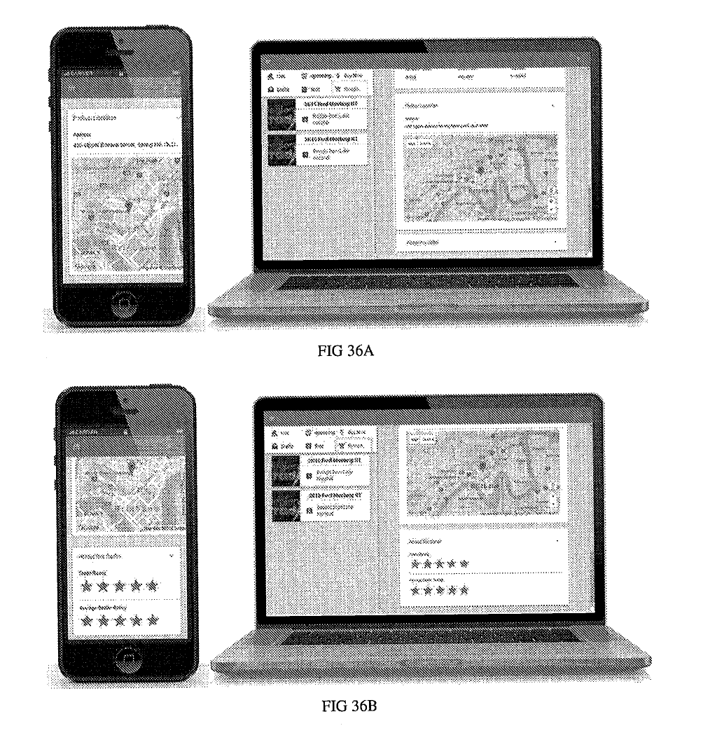

The winning buyer may also view the details of the vehicle (as illustrated in FIGS. 35A and 35B), along with the pickup location (FIG. 36A) and the rating that other buyers have given to the seller (FIG. 36B).

According to certain embodiments, the auction is automatically extended when bids are received in proximity to an end of the auction. As an illustrative example, an auction may be extended by 5 minutes, for example, if a bid is received within 30 seconds of a scheduled end time of an auction. This provides an opportunity for bidders that are outbid near an end of the auction to provide further bids. The amount of time by which an auction is extended, and the proximity to the end of the auction at which the time is extended may be customised to suit various needs, and need not be the same for all auctions performed by the system 10.

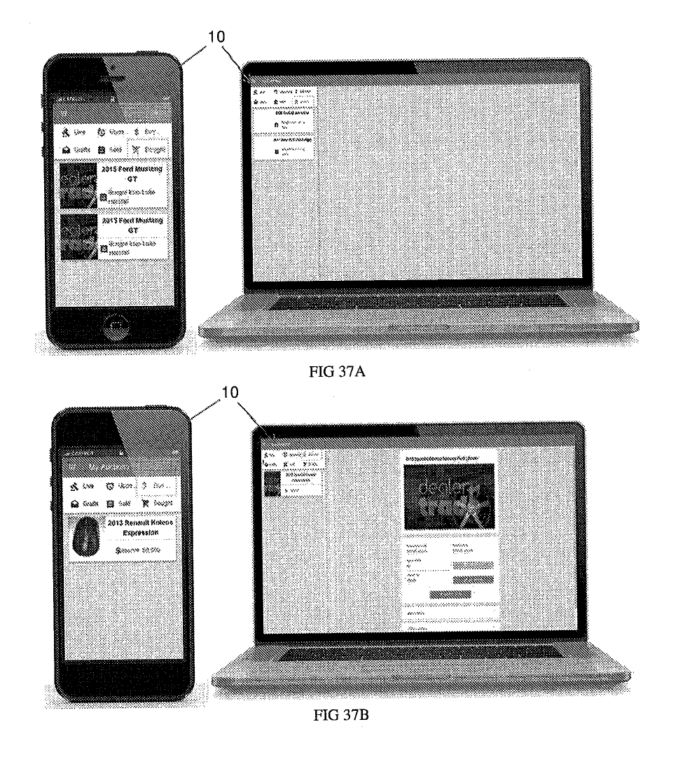

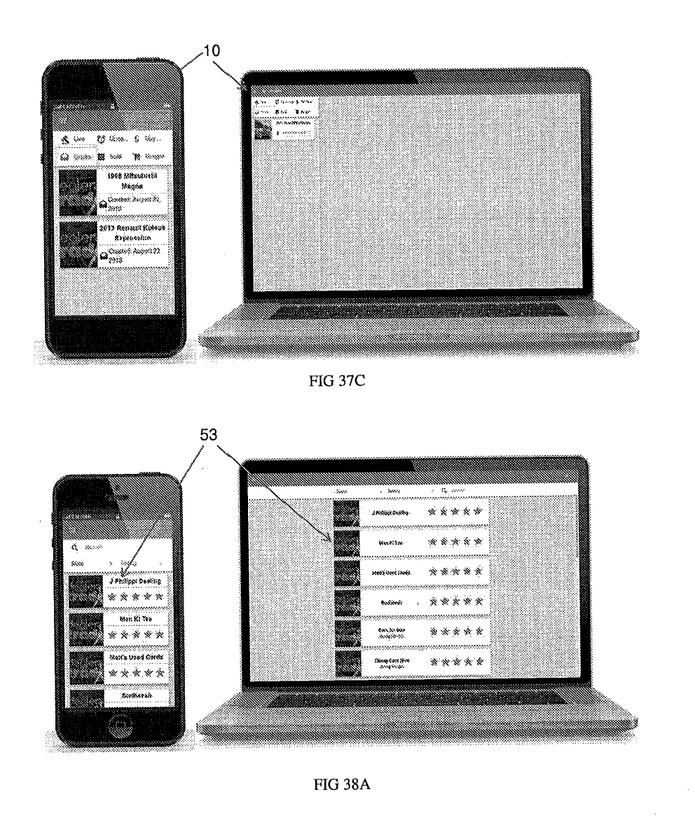

As illustrated in FIGS. 37A, 37B and 37C, the online motor vehicle sales system 10 allows a user to filter the vehicles that the user is watching with a view to a possible purchase by listing type. For instance, in FIG. 37A the user can filter watched vehicles that are in live auctions. Alternatively, the user can filter watched vehicles in upcoming auctions (FIG. 37B) and vehicles that are listed in “buy now” format (FIG. 37C).

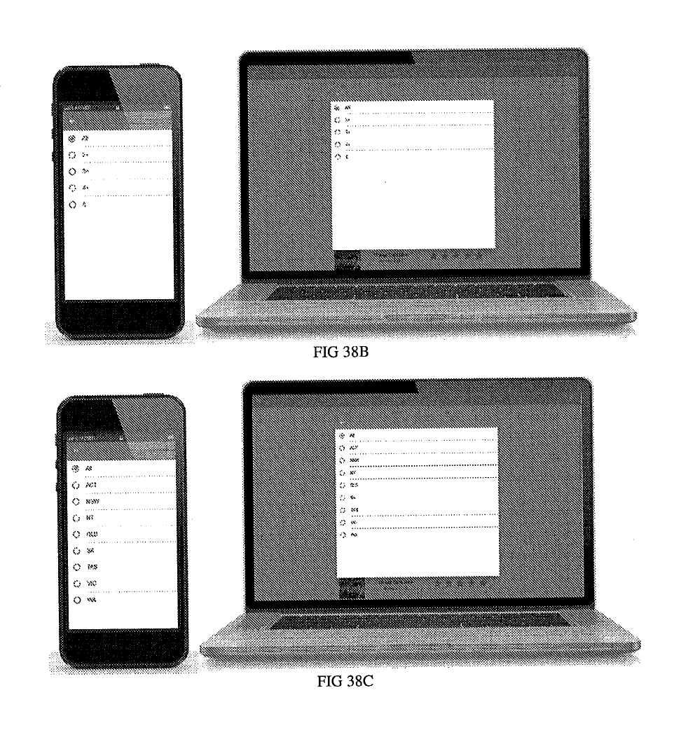

In FIG. 38A, a list 53 of motor vehicle dealerships is provided. A user may search within the list 53 by using filters such as dealership ratings (FIG. 38B) or the state or territory in which the dealership is located (FIG. 38C). In this way, a user may identify dealerships located in a similar geographic location to the user and/or dealerships having a particular rating given to them by buyers.

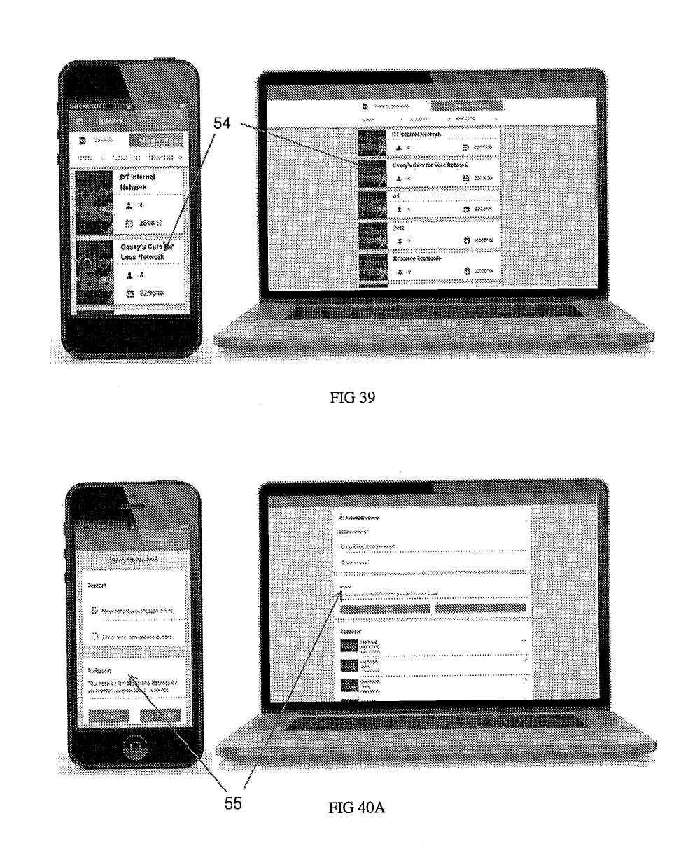

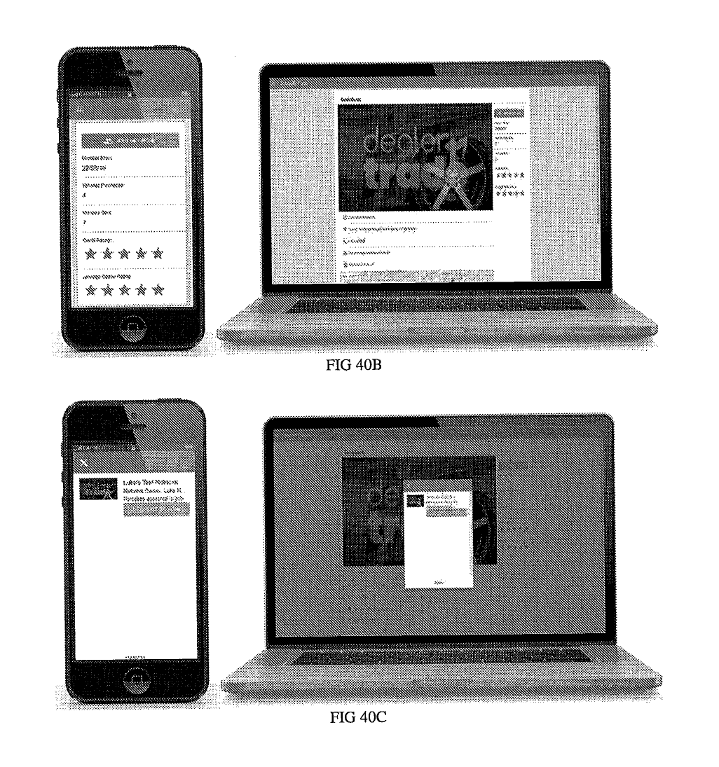

In FIG. 39, an interface showing a list 54 of searchable dealer networks is illustrated. If a user wishes to join a particular network, the user may select the network fron the list 54.

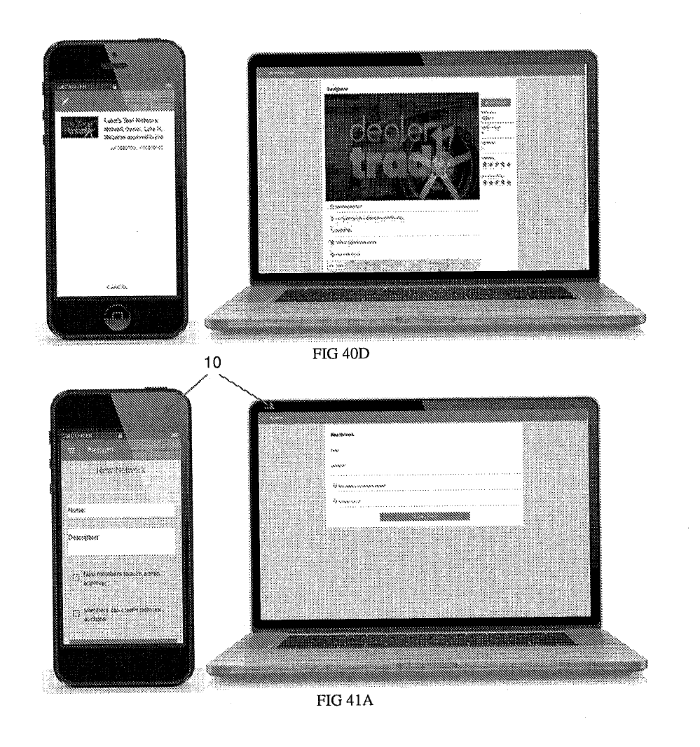

If a user has been invited to join a particular network, an invitation 55 as illustrated in FIG. 40A is displayed in the online motor vehicle sales system 10. The user may then either accept or decline the invitation to join the network.

Alternatively, if a user wishes to join a particular network, the user can firstly view details of the network (FIG. 40B) prior to joining. In some embodiments of the invention, a request to join a network may be automatically accepted. In other embodiments of the invention, however, the user may first request to join a network (FIG. 40C) and an administrator of the network will either accept or decline the user's request. The user will be informed that their request is pending (FIG. 40D) until the administrator decides whether to accept or decline the request.

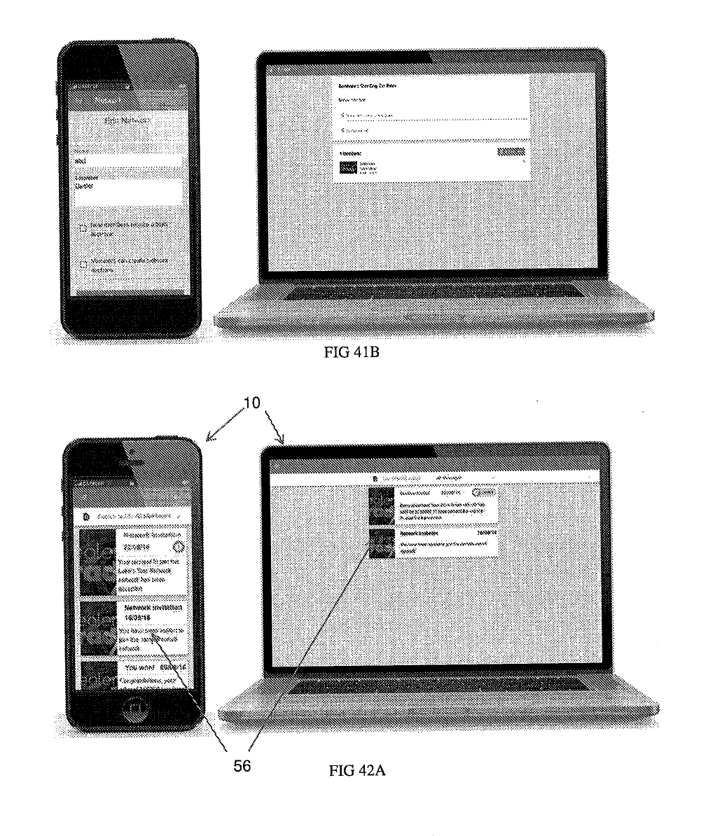

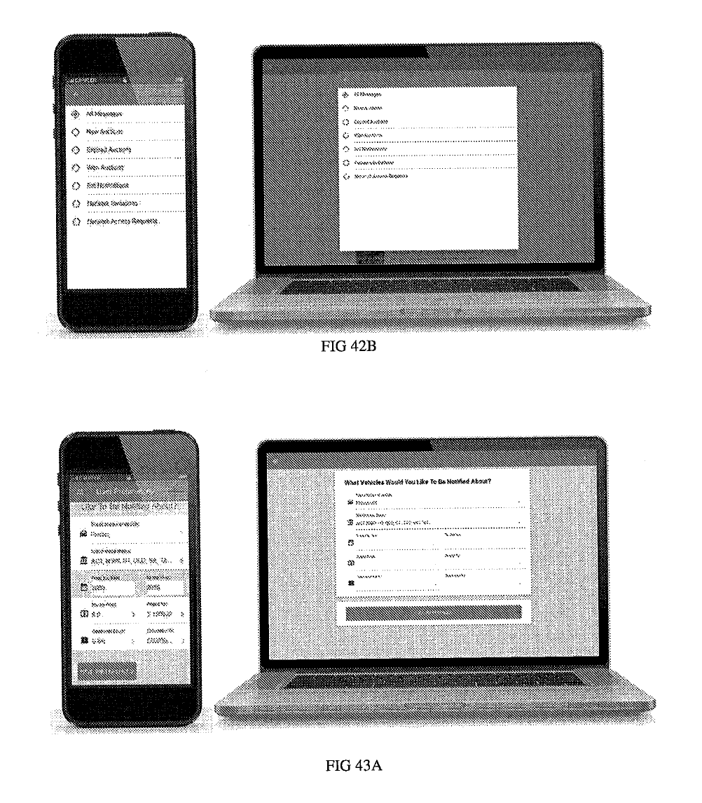

In FIG. 41A an interface is shown in which a user may create a new network within the online motor vehicle sales system 10. Alternatively, an administrator of an existing network may modify the network using the interface illustrated in FIG. 41B.

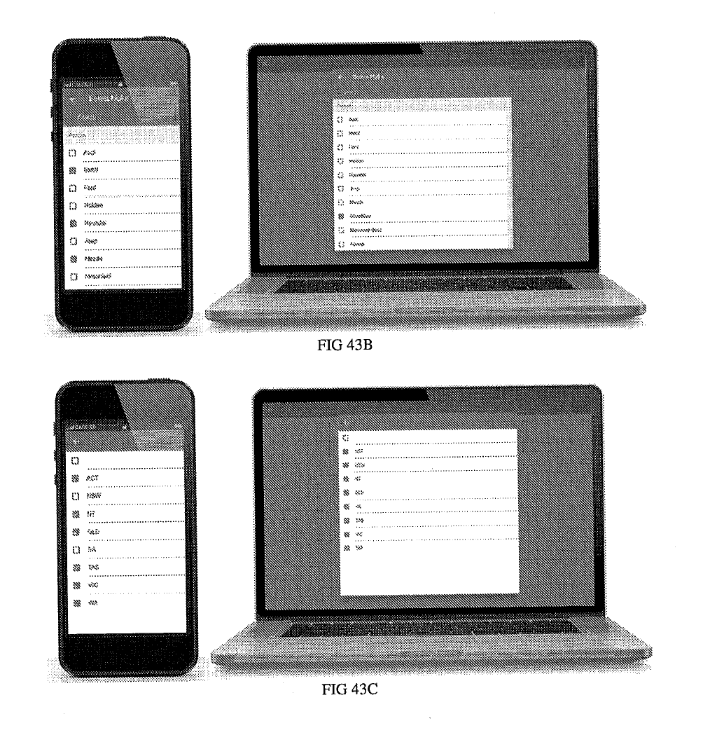

The online motor vehicle sales system 10 provides each user with a list of notifications 56 relating to all of the user's activities in the motor vehicle sales system 10, as illustrated in FIG. 42A. In FIG. 42B it is illustrated that a user may filter the notifications 56 by the type of notification (such as new auctions, expired auctions, won auctions, bid notifications, network invitations and network access requests).

The online motor vehicle sales system 10 allows a user to select the type of notifications that are received based on one or more selected preferences. For instance, in FIG. 43A a user may choose to be provided with notifications only about certain makes or models of vehicles within particular geographic locations. Further, the user may prefer to receive notifications only about vehicles made within a particular timeframe, that are priced within a particular range and/or have an odometer reading within a particular range.

If a user elects to be notified only about certain makes of vehicle, the user may select all desired makes of vehicle in the interface illustrated in FIG. 43B. Similarly, the user may select the geographic location of vehicles about which the user wishes to be notified using the interface illustrated in FIG. 43C.

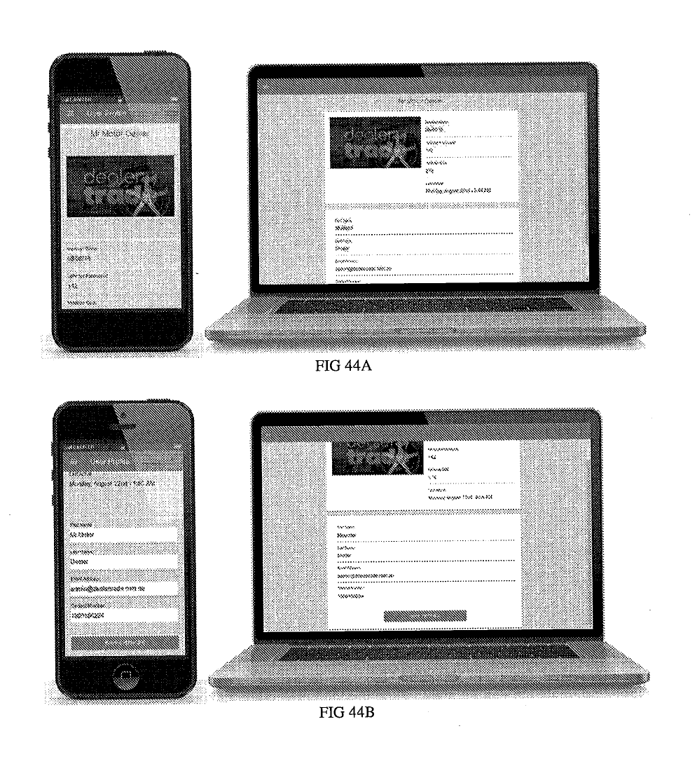

As illustrated in FIGS. 44A and 44B, the user may edit their profile using the Edit Profile interface 57. The user may edit their name, email address and contact telephone number as required.

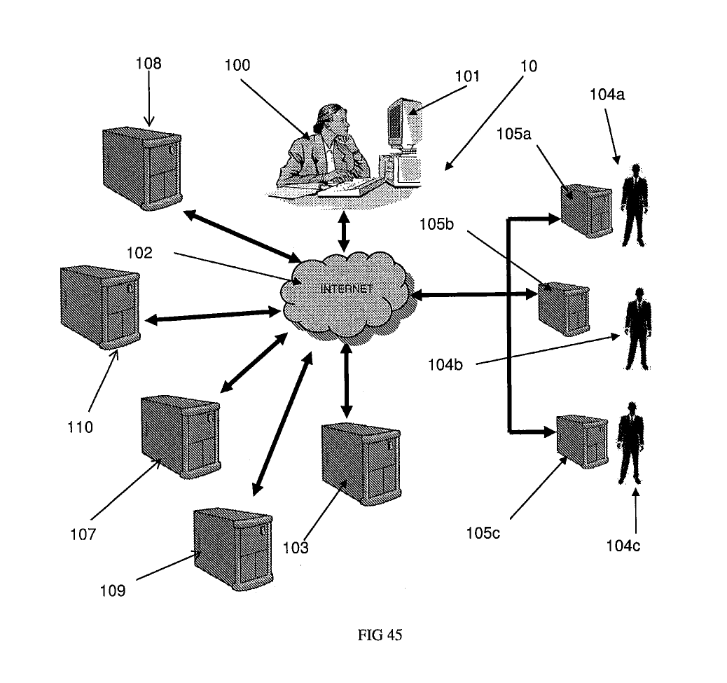

In FIG. 45 there is illustrated a schematic diagram of an online motor vehicle sales system 10 according to an embodiment of the present invention. Before a seller 100 can generate a sale offer using the online motor vehicle sales system 10, the seller must register with the online motor vehicle sales system 10. Thus, the seller 100 enters their registration information into a registration interface provided via the internet on an electronic device 101 of the seller 100. In the embodiment of the invention shown in FIG. 45, the seller 100 must provide a motor vehicle dealer licence number in order to register. Thus, once the seller 100 has entered their registration information (including the motor vehicle dealer licence number) into the registration interface, the registration information is received via the internet 102 by the online motor vehicle sales system server 103. The online motor vehicle sales system server 103 consults with (via the internet 102) a motor vehicle dealer licence server 108 containing an electronic database maintained by an authority (such as a government authority) of motor vehicle dealer licences. If the online motor vehicle sales system server 103 receives confirmation from the motor vehicle dealer licence server 108 that the registration information is correct and valid, the seller 100 may then complete the registration process and become a registered user.

The online motor vehicle sales system 10 allows a registered user (in this case a seller 100) to enter a sale offer into the seller's electronic device 101 (computer, mobile telephone, computing tablet etc.). In order to generate the sale offer, the seller 100 must enter the motor vehicle's registration number (or similar identifier) into a sale offer interface. Once this information is entered, the online motor vehicle sales system server 103 consults with (via the internet 102) a vehicle registration server 107 containing an electronic database maintained by an authority (such as a government authority) of motor vehicle registrations. The vehicle registration server 107 may provide information via the internet 102 to the online motor vehicle sales system server 103 including registration details, vehicle identification details (such as a VIN), information regarding whether a security has been registered on the motor vehicle, information regarding whether the vehicle has been reported stolen and the like.

Upon receipt of the information from the vehicle registration server 107, the online motor vehicle sales system server 103 consults with (via the internet 102) a vehicle information server 109 to obtain further information regarding the vehicle (such as a National Vehicle Identification Code (NVIC)). The NVIC may be obtained using the VIN received from the registration server 107.

The online motor vehicle sales system server 103 may also consult with a further vehicle information server 110 (via the internet 102) using the NVIC obtained from the vehicle information server 109 to obtain further information regarding the vehicle (such as the manufacture information, vehicle information, price guide, engine information, rating information and/or warranty and service periods).

The online motor vehicle sales system server 103 automatically populates the sale offer interface for the seller 100 based on the information received from servers 107, 109 and 110 and allows the seller to complete the sale offer. In circumstances in which the information provided by the vehicle registration server 107 is adverse (such as if the vehicle has been reported as stolen) the seller 100 will be unable to complete the sale offer.

Once completed, the sale offer is sent from the seller's electronic device 101 via the internet 102 to the online motor vehicle sales system server 103. The online motor vehicle sales system server 103 houses an electronic database of buyers 104a, 104b, 104c and forwards the sale offer from the seller 100 to at least one of the buyers 104a, 104b, 104c.

Prior to forwarding the sale offer to the buyers 104a, 104b, 104c, however, the online motor vehicle sales system server 103 checks to ensure that the motor vehicle being offered for sale

The sale offer is sent by the online motor vehicle sales system 10 to electronic devices 105a, 105b, 105c (computers, mobile phones, computing tablets etc.) connected via the internet 102 with the online motor vehicle sales system server 103 and associated with the buyers 104a, 104b, 104c.

Upon receipt of the sale offer, one or more of the buyers 104a, 104b, 104c may generate a purchase offer. These purchase offers are submitted via the internet 102 to the online motor vehicle sales system server 103 using the electronic devices 105a, 105b, 105c of the buyers 104a, 104b, 104c.

At least one of the purchase offers is sent from the online motor vehicle sales system server 103 via the internet 102 to the electronic device 101 of the seller 100. The seller 100 may then view the purchase offers using the electronic device 101 and, if a purchase offer is satisfactory, accept the purchase offer using the electronic device 101. Acceptance of the purchase offer is sent by the online motor vehicle sales system 10 via the internet 102 to the online motor vehicle sales server 103, from where a notification regarding the acceptance of the purchase offer is sent via the internet 102 to the buyer who made the accepted purchase offer. Notifications regarding the non-acceptance of other purchase offers may be sent to the unsuccessful buyers if desired.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. An online motor vehicle sales method including at least one server, the method including the steps of:
a. generating, with an online motor vehicle sales system, a motor vehicle sale offer from a seller, the motor vehicle sale offer including information received from two or more external electronic databases in electronic communication with the online motor vehicle sales system;
b. maintaining an electronic database of one or more buyers in association with the online motor vehicle sales system;
c. sending, with the online motor vehicle sales system, the motor vehicle sale offer to at least one of the one or more buyers;
d. receiving, with the online motor vehicle sale system, a purchase offer from at least one of the buyers to whom the motor vehicle sale offer was sent;
e. accepting, with the online motor vehicle sales system, a preferred purchase offer; and
f. sending, with the online motor vehicle sales system, a notification regarding the acceptance of the preferred purchase offer to the buyer who made the preferred purchase offer.

2. An online motor vehicle sales method according to claim 1 wherein the seller and the one or more buyers are required to register with the online motor vehicle sales system before access to the online motor vehicle sales system is granted.

3. An online motor vehicle sales method according to claim 1 wherein the purchase offer includes a purchase price.

4. An online motor vehicle sales method according to claim 1 wherein the seller, when generating the sale offer, selects the length of time for which the sale offer remains open.

5. An online motor vehicle sales method according to claim 1, wherein the electronic database of one or more buyers includes at least dealership registration associated with multiple motor vehicle dealers.

6. An online motor vehicle sales method according to claim 1, wherein one or more pieces of information regarding, the motor vehicle to be sold are entered by the seller, and wherein the information received from the two or more external electronic databases is according to the entered one or more pieces of information.

7. An online motor vehicle sales method according to claim 6, wherein the pieces of information include at least one of vehicle make, model, colour, odometer reading, registration number, vehicle information number (VIN), year of manufacture, and sale price.

8. An online motor vehicle sales method according to claim 6, further comprising accessing one or more electronic databases to verify that the one or more pieces of information supplied by the seller are valid.

9. An online motor vehicle sales method according to claim 1, wherein the information received from two or more external electronic databases includes whether there are securities registered over the vehicle, whether there are outstanding fines attributed to the vehicle, and/or whether the vehicle has been reported as stolen.

10. An online motor vehicle sales method according to claim 1, further comprising, receiving a Vehicle Identification Number (VIN) from a seller, retrieving a VIN from an external electronic database based upon other vehicle information data, and determining whether the seller entered VIN matches the VIN from the external electronic database.

11. An online motor vehicle sales method according to claim 1, wherein the seller selects, at least in part, the buyer or buyers to which the sale offer is sent.

12. An online motor vehicle sales method according to claim 1, wherein potential buyers are able to select filters, defining what sales offers are received, wherein the at least one of the buys is sent the motor vehicle sale offer according to the selected filters.

13. An online motor vehicle sales method according to claim 1, comprising receiving, with the online motor vehicle sales system, a plurality of purchase offers, and sending a subset of the plurality of purchase offers to the seller.

14. An online motor vehicle sales method according to claim 13, wherein the plurality of purchase offers are each associated with a purchase price, and the subset of purchase offers is, generated according to the purchase price.

15. An online motor vehicle sales method according to claim 1, further comprising a payment interface, configured to enable a buyer to transfer payment for the motor vehicle to the seller.

16. An online motor vehicle sales method according to claim 1, wherein the online motor vehicle sales system may include one or more groups or networks of buyers to which the seller may make the sale offer available.

17. An online motor vehicle sales system including at least one computational device configured to:
Receive a motor vehicle sale offer from a seller, the motor vehicle sale offer including information received from two or more external electronic databases in electronic communication with the online motor vehicle sales system;
maintain an electronic database of one or more buyers;
send the motor vehicle sale offer to at least one of the one or more buyers;
receive a purchase offer from at least one of the buyers to whom the motor vehicle sale offer was sent;
accept a preferred purchase offer; and
send a notification regarding the acceptance of the preferred purchase offer to the buyer who made the preferred purchase offer.

18. An online motor vehicle sales method including at least one server, the method including the steps of:
a. generating, with an online motor vehicle sales system, a motor vehicle sale offer from a seller, the motor vehicle sale offer being generated by:
i. entering two or more pieces of information relating to a motor vehicle into the online motor vehicle sales system;
ii. sending, with the online motor vehicle sales system, one of the one or more pieces of information to a first external electronic database;
iii. receiving, from the first external electronic database with the online motor vehicle sales system, one or more further pieces of information relating to the motor vehicle;
iv. sending, with the online motor vehicle sales system, the one or more further pieces of information to a second external electronic database;
v. receiving, from the second external electronic database with the online motor vehicle sales system, one or more additional pieces of information relating to the motor vehicle;
vi. checking, using the online motor vehicle sales system, that the one or more further pieces of information and the one or more additional pieces of information relate to the same motor vehicle as the two or more pieces of information;
vii. populating, with the online motor vehicle sales system, the sale offer with the two or more pieces of information, the one or more further pieces of information and the one or more additional pieces of information;
b. maintaining an electronic database of one or more buyers in association with the online motor vehicle sales system;
c. sending, with the online motor vehicle sales system, the motor vehicle sale offer to at least one of the one or more buyers:
d. receiving, with the online motor vehicle sale system, a purchase offer from at least one of the buyers to whom the motor vehicle sale offer was sent;
e. accepting, with the online motor vehicle sales system, a preferred purchase offer; and
f. sending, with the online motor vehicle sales system, a notification regarding the acceptance of the preferred purchase offer to the buyer who made the preferred purchase offer.
